(19) United States
(12) Patent Application Publication
(10) Pub. No.: US 2005/0010416 A1
(43) Pub. Date: Jan. 13, 2005

(54) System and method for self management of health using natural language interface

(75) Inventors: Timothy A. Anderson, Sudbury, MA (US); P. David Lebling, Concord, MA (US); Lowell B. Hawkinson, Belmont, MA (US)

Correspondence Address: WILMER CUTLER PICKERING HALE AND DORR LLP, 60 STATE STREET, BOSTON, MA, 02109, US

(73) Assignee: Gensym Corporation

(21) Appl. No.: 10/862,277

(22) Filed: Jun. 7, 2004

Related U.S. Application Data
(60) Provisional application No. 60/485,594, filed on Jul. 9, 2003.
(60) Provisional application No. 60/506,828, filed on Sep. 29, 2003.
(60) Provisional application No. 60/510,011, filed on Oct. 9, 2003.
(60) Provisional application No. 60/559,865, filed on Apr. 6, 2004.

(51) Int. Cl. G10L 15/00

(52) U.S. Cl. 704/271

(57) ABSTRACT

Systems and methods for the self management of health using a natural language interface. A system or method for self-management of health initiates dialogue with a user to solicit health information from the user using a natural language (NL) interface; In addition, the system or method may respond unsolicited health information from the user provided via a NL interface. The health information from the user is semantically processed in accordance with pre-specified health management rules to facilitate user self management of health. The natural language interface is a constrained natural language. The natural language interface interacts with a speech recognition system. The health management logic includes a common sense reasoning logic to semantically process NL input from the user according to rules to emulate common sense reasoning.

### CROSS REFERENCE TO RELATED APPLICATIONS

This application claims the benefit under 35 USC 119(e) of the following U.S. Provisional Patent Applications:
60/485594, filed on Jul. 9, 2003, entitled LIFEVISOR™ FOR DIABETES PRODUCT REQUIREMENTS DOCUMENT;
60/506828, filed on Sep. 29, 2003, entitled SOFTWARE PLATFORM FOR DEVELOPING NEXT GENERATION LIFE MANAGEMENT PRODUCTS AND SERVICES;
60/510011, filed on Oct. 9, 2003, entitled ADVANCED SOFTWARE AS A PRESCRIPTION FOR THOSE WITH A SELF-MANAGEABLE CHRONIC DISEASE; and
60/559865, filed on Apr. 6, 2004, entitled ADVANCED SOFTWARE AS A PRESCRIPTION FOR THOSE WITH A SELF-MANAGEABLE CHRONIC DISEASE.

### BACKGROUND

1. Field of the Invention

This invention relates generally to advanced software used to assist individuals in the management and support of chronic disease.

2. Discussion of Related Art

Increasing life expectancy and decreasing physical activity have led to increasing incidence of chronic, rather than acute, diseases, such as diabetes, and to increasing incidence of physical problems such as obesity. Management of such conditions is only practical if the primary responsibility for it, for most patients, is with the patient, rather than with medical professionals. The general approach taken includes patient education, intervention by health care staff, and the use of various monitoring devices to obtain important data such as weight and (for diabetes) blood glucose levels, possibly remembering them (rather than requiring manual logging) for later analysis, and ultimately providing the logs to the patient's care providers.

A relatively common technology specific to diabetes is blood glucose monitors. The simplest ones analyze a blood sample and produce a blood glucose level, which the user can write in a log book. More advanced forms keep a history in memory, and even allow the history to be transferred to a personal computer (by a serial, or more recently wireless, connection) for analysis by associated software. The most advanced such meters currently provide fairly simple manual logging of exercise, diet, and so on: the user can enter the number of calories consumed by exercise, or the calorie and carbohydrate values for any given meal.

More advanced software, independent of hardware monitors, allows easier tracking of things like meals and exercise. There is now software with the FDA nutrition database incorporated, allowing relatively sophisticated meal planning and recording, including the ability to enter the ingredients from a recipe in order to at least approximate the nutritional information for a dish one is cooking. Similarly, exercise databases include good estimates of calorie consumption for different forms of exercise, depending on intensity, duration, body weight, and so on. Such software runs on pocket-portable devices like PDAs.

In all of these cases, the software is simply recording the information it is given, when the user gives it. There is no notion of a flexible schedule, nor any ability for the device to adjust its behavior based on previous inputs from the user. One can enter new dishes, or define common meals, but any such change must be made explicitly by the user.

Good results for chronic diseases such as diabetes have been produced, at relatively high cost, by systems where patients are called periodically to check on their progress. The cost per patient is typically too high to permit this level of care for any but the most severe cases.

Health Hero provides a static system where the patient is prompted to answer various questions on his condition and behavior. The device provides immediate feedback based on the answers, and also transmits the answers by telephone to the patient's care provider. See, e.g., U.S. Pat. No. 5,307,263.

### SUMMARY

The invention provides systems and methods for the self management of health using a natural language interface.

According to one aspect of the invention, a system or method for self-management of health initiates dialogue with a user to solicit health information from the user using a natural language (NL) interface; In addition, the system or method may respond to unsolicited health information from the user provided via a NL interface. The health information from the user is semantically processed in accordance with pre-specified health management rules to facilitate user self management of health.

According to another aspect of the invention, the natural language interface is a constrained natural language.

According to another aspect of the invention, the natural language interface interacts with a speech recognition system.

According to another aspect of the invention, the health management logic includes a common sense reasoning logic to semantically process NL input from the user according to rules to emulate common sense reasoning.

### BRIEF DESCRIPTION OF THE DRAWING

In the Drawing,

FIG. 1 is an illustration of an exemplary architecture of a preferred embodiment of the invention;

FIG. 2 is an exemplary portion of exemplary profiles according to certain embodiments of the invention, showing knowledge related to a history of blood glucose measurements;

FIG. 3 is an exemplary portion of exemplary profiles according to certain embodiments of the invention, showing knowledge to support reasoning about drug side effects;

FIG. 4 is an exemplary display according to certain embodiments of the invention;

FIGS. 5A-5C are depictions of exemplary structures according to certain embodiments of the invention;

FIGS. 6A-6C are exemplary portions of exemplary profiles according to certain embodiments of the invention;

FIG. 7 is an exemplary portion of exemplary profiles according to certain embodiments of the invention;

FIG. 8 is a flowchart describing exemplary profile loading logic according to certain embodiments of the invention;

FIGS. 9-13 are exemplary portions of exemplary profiles according to certain embodiments of the invention; and

FIG. 14 is an exemplary display according to certain embodiments of the invention.

### DETAILED DESCRIPTION

As the cost of health care rises, and as improved treatment of acute illnesses leads to a greater proportion of chronic disease, it has become more important for patients suffering from chronic disease to assist in their own treatment. In the case of diabetes, where careful monitoring and control of blood glucose levels, diet, exercise, and stress is required for patients to remain relatively healthy, self-management is essential; with many other conditions, such as chronic heart disease and obesity, patients also can benefit by taking better care of themselves.

In much of what follows, examples are drawn from the specific fields of weight control and diabetes management. It will be apparent that this does not imply a limitation of the present invention to that field: management of things like diet, exercise, and medication is equally applicable to patients with heart disease, or even to people who just want to manage their weight better.

Preferred embodiments of the invention attempt to support all aspects of managing the targeted condition. In the case of diabetes, patients who are effectively managing their condition will carefully monitor: their diet, with particular attention to carbohydrates; their blood glucose levels; prescribed medications; stress levels; exercise; and weight—obesity is often a factor in the onset of type 2 diabetes. By “monitor” we mean two things. First, the patient should record information about all these things: what food was consumed when, what blood glucose levels were, what drugs were used when, and so on; a complete and accurate log is quite helpful to the patient's care providers in establishing the course of treatment. Second, the patient should be sure to follow the prescribed course of treatment: he should keep his blood glucose level within specified limits, which means that he should check it on a regular basis; he should carefully balance exercise, food consumption, and medications so as to control his weight as well as his blood glucose; he may have to adjust his diet and medication in response to unusual stress. To support the patient, preferred embodiments of the invention will: facilitate the maintenance of suitable logs, and their transmission to the patient's care providers; provide appropriate reminders, whether time-based or event-based (“According to your usual schedule, now would be a good time to take your lunchtime dose of medication,” or, “Since you just had an unusually strenuous workout, you might want to check your blood glucose level.”); and, provide information and assistance to the patient, such as the nutritional value of various meals, the effects of medications, suitable exercise plans, and so on. This information may be tailored to comply with pertinent regulation. Many existing devices and software packages support the maintenance of activity logs, and provide nutritional information, but fail to combine that with intelligence in interpreting the data coming back from the patient, and with intelligently-scheduled reminders of appropriate actions.

Managing one's weight is somewhat less demanding, in that it's not necessary to monitor one's blood glucose levels, and prescription medications are generally not related to that specific problem, but the needs are similar. The user should still be watching what he eats, balancing exercise with food intake, monitoring his stress levels, and so on; in addition, he may have prescription medications, such as drugs to lower cholesterol, that are taken on a schedule. Again, an embodiment of the invention applied to this field would support logging and planning, as well as providing intelligent reminders to the user and interpreting the user's input with respect to the effect of particular actions on the user's weight control plan.

Preferred embodiments of the invention are “smart phone” devices with computational power, communication ability via the cellular telephone network, and software to provide intelligent and accessible assistance in the management of many aspects of an individual's health. Some embodiments might be built using a personal computer, which is not in general portable; others might depend on computational power available on a computer network such as the World Wide Web, thus requiring a connection to the network in order to be fully usable; still others might use a personal digital assistant (PDA), which, although portable, may not have direct access to the telephone network. Although much of the value of the invention follows from its constant availability, such compromises with the current state and price of technology are consistent with its basic design.

More specifically, the preferred embodiment is implemented on a cell phone, with a small display screen, the ability to use the phone hardware (microphone and earpiece or speaker) as input and output for the software, and connectivity to devices such as accelerometers or blood glucose meters. The primary requirements are sufficient processor power and memory size to run the software. Devices with larger display screens, better microphones, and so on are better suited to this application; we assume that advances in hardware technology will continue, providing continuous improvement over time.

The device's software includes a core set of knowledge to enable natural communication with the user, reasoning about management of the user's health, and reasoning about other aspects of the user's life. In the preferred embodiment the knowledge base is like that described in U.S. patent application Ser. No. 10/627,799 (which is hereby incorporated by reference in its entirety), with the knowledge stored in a tree structure based on English words and phrases. The knowledge store comprises basic English vocabulary, as well as specific information about medical conditions relevant to the user, the recommended course of treatment and management, and the system state. Although much of the knowledge store will be identical for all users of the device, preferred embodiments require configuration before they can be used effectively: typically the user's care provider will enter information about the recommended course of treatment (prescriptions, diet, and so on); over time, the contents of the knowledge store in a particular user's device will evolve to reflect changes in the patient's condition, changes in his recommended course of action, and changes in medical knowledge. As described below, the knowledge store in preferred devices modifies or omits features in U.S. patent application Ser. No. 10/627,799.

The most important function of the device is assisting in the management of the user's health. Preferred embodiments include a separate body of computer software, external to the knowledge base, to provide that assistance using the contents of the knowledge base as its data store; some embodiments, as in U.S. patent application Ser. No. 10/627,799, may move the management expertise into code stored in the knowledge base, with an unspecialized engine to execute it. In preferred embodiments, communication with the user is treated as one or more ongoing conversations, which by preference the device initiates and manages; these can be carried on using whatever mix of speech and GUI input and output that the user finds most convenient.

Even disease-specific management expertise involves “common-sense” reasoning—the sort of reasoning that people do without really being aware of it. As in U.S. patent application Ser. No. 10/627799, preferred embodiments have the ability to deal with specific problems in several domains: interpreting an English-language phrase as a specific time, for example, or managing an inventory of supplies (prescription drugs, test strips for a blood glucose monitor, etc.).

For chronic disease, it is important that the patient adhere to his treatment and disease management regimen over a long period of time: if he stops, or follows it only sporadically, much of the value is lost. It is therefore important for the device to be attractive at the outset, and for it to provide reasons for the user to keep using it. Preferred embodiments include knowledge and logic to evaluate usage patterns, and to provide rewards in some form to encourage appropriate use. These could include different games made available on the device, sponsored discounts, frequent flyer miles, new ring tones, or any number of other incentives, depending on the market and the user.

Preferred embodiments of the invention use the initial contents of the knowledge base, which often will include user-specific data input by a care provider, and data input by the user from time to time, such as food consumption, to help the user manage his treatment. In addition, the device can use input from various monitoring devices specific to the user's condition. For example, it is very important for diabetics to monitor their blood glucose level; they often use current levels in planning diet and medication. In preferred embodiments as applied to diabetes, the blood glucose monitor and the current invention communicate directly, via a serial cable or a wireless connection, but a cheaper implementation might require the user to enter the current reading either through the GUI or by speaking it to the device. The input from any number and type of such devices can be used by the device, depending on the disease to be managed: a heart monitor might be useful in some cases, or an accelerometer to get an objective measurement of exercise levels.

The device will typically require configuration by a care provider before it can be used by a particular patient. Some of its value also resides in its ability to provide information to the care provider once it's been used: a record of blood glucose readings since the last office visit, for example, or a record of diet and exercise. At the same time, the care provider might periodically need to update information in the knowledge base to reflect a new prescription, a new diet recommendation, or even a new diagnosis. Preferred embodiments provide a separate interface to the care provider, connected to the device either via a network or a direct cable, for this access. Separating care provider access from normal user access makes it easier to provide the necessary levels of security (the patient may have personal information on the device that the care provider should not see, and there may be some aspects of the knowledge, such as recommended drug usage, that the user should not alter), and can also permit in some embodiments remote access to the device by the care provider. The care provider interface in preferred embodiments is implemented in conjunction with separate software running on a conventional desktop PC, so it interacts only with that software. This simplifies the implementation of the device itself, and allows care providers to use an interface better tailored to their needs.

In addition, preferred embodiments of the invention will contain facilities to access the World Wide Web, whether via a modem connection, a wireless connection, or a cable to a connected computer. This gives the device the ability to obtain updated information about the disease, software updates, and so on, and to act on the user's behalf where possible: with such a connection it can access services that permit it to renew prescriptions or order supplies, for example. It will be seen that other connections would fit with the architecture and capabilities of the device. Some embodiments include the ability to access cellular telephone networks, giving them the ability to reach the Internet, to originate phone calls, or to send short text messages; with voice synthesis capabilities, this would permit the device to convey urgent information to a care provider, or even to remind the user of something, should he not be carrying the device.

Exemplary Architecture

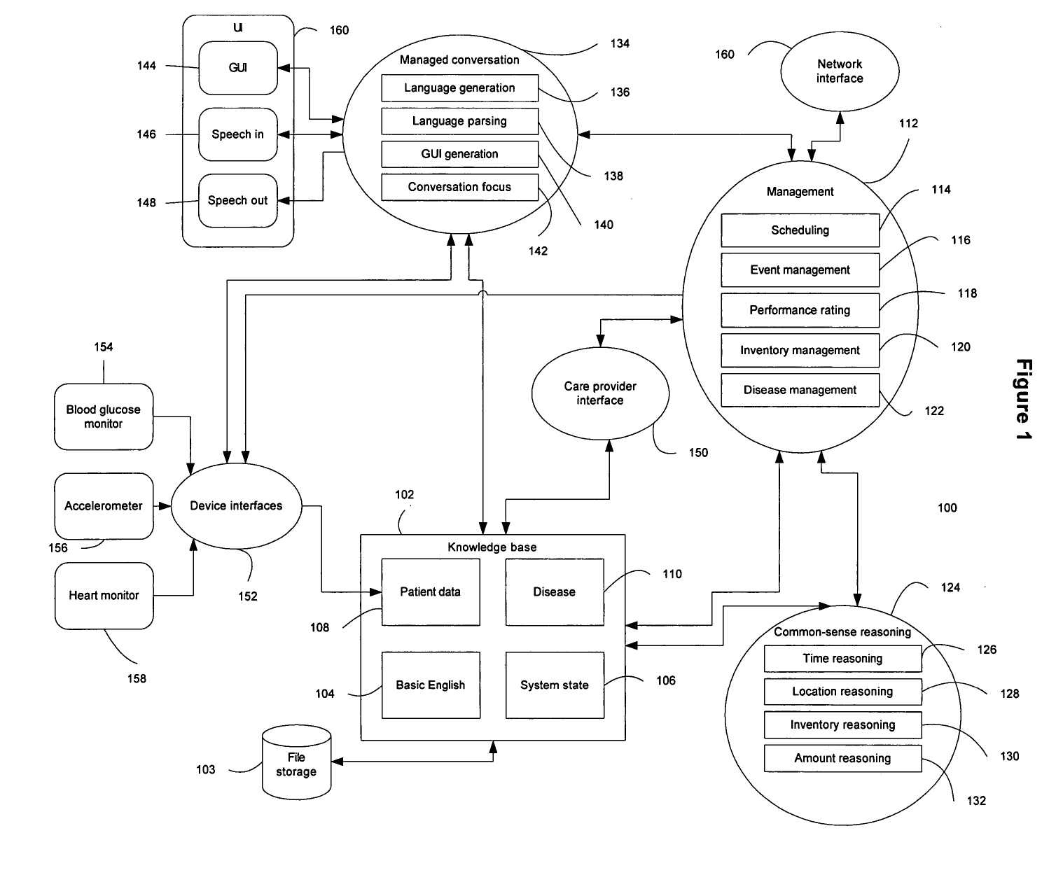

FIG. 1 illustrates exemplary software architectures according to certain embodiments of the invention. The exemplary architecture includes a knowledge base 102, a common-sense reasoning module 124, a management module 112, a conversation module 134, a care provider interface 150, device interfaces 152, and a network interface 160.

The knowledge base 102 is, in preferred embodiments, largely as described in U.S. patent application Ser. No. 10/627,799. Although the entire knowledge base is a single tree, it is useful for discussion to identify several components, as shown in FIG. 1. Basic English module 104 contains the basic vocabulary and knowledge required to carry on a conversation: word parts of speech, irregular word forms, and pronunciations, as well as some representation of the meaning and relationships of words and phrases. The structure, and much of the knowledge, would be identical for many other applications. This part of the knowledge base is largely static-although it could be changed during normal use of the device, such changes would be small and very infrequent.

The knowledge base is stored in some form of file storage 103. The nature of this storage depends on the particular hardware used in an embodiment of the invention. As discussed in U.S. patent application Ser. No. 10/627,799, and later in this document, the stored form of the knowledge base will generally consist of a snapshot of the entire profile taken at a certain time, with one or more journal files reflecting changes made since that time.

System state 106 contains information used by other parts of the invention, and is largely dynamic. In preferred embodiments this includes schedules and agendas for the management module 112, and access control data for the care provider interface 150; some embodiments add the state of any conversations in progress in the Managed conversation module 134. Preferred embodiments use the knowledge base 102 for this information for several reasons: flexibility, support for reasoning where required, consistency of access, and crash recovery. Other embodiments might store some or all of this information outside the knowledge base, perhaps trading flexibility for improved performance, without changing the basic logic of the system.

Disease information 110 and patient data 108 are closely related. Disease information 110 is analogous to basic English 104: both are relatively static, changing significantly only when the software in the device is updated. The disease information includes the vocabulary and concepts, extensions of basic English 104, required to converse about the user's disease(s), which of course may vary in different embodiments of the device, or for different users of the same device. In addition, disease information 110 is where the device stores its knowledge about management of chronic disease in general, and of a specific chronic disease such as diabetes. This might include nutritional information about various foods, knowledge about the different drugs that can be used to treat the disease, the effects of different types of exercise, and so on. As discussed below, the user's ability to modify the information stored here is properly limited: insofar as medical benefits can arise from the use of this invention, they depend on the availability of accurate information about management of specific diseases. In preferred embodiments, such access controls are implemented as extensions of the knowledge architecture in U.S. patent application Ser. No. 10/627,799.

As disease information 110 is analogous to basic English 104, patient data 108 is analogous to system state 106. It includes, in addition to relatively static information such as the exact nature of the user's disease, details about the recommended course of treatment and all the data collected by the device: in the case of diabetes, for example, readings from a blood glucose monitor, as well as exercise and diet information that might be entered directly by the user. There are obviously many links between the disease information 110 and the patient data 108; since in preferred embodiments both are physically part of the same knowledge base, this is easily managed. Although the device as described here is for use by one person, with special access for his care providers, the knowledge base could easily support several users: several distinct patient data sections can easily be stored in the knowledge base, identified for example by the user's name, and used as required by the software. However, the additional complexity of this, and the elimination of the ability to carry the device on one's person, make it unattractive for preferred embodiments of the invention.

Preferred embodiments of the invention use the common-sense reasoning module 124 to improve the device's ability to handle complex problems such as scheduling and inventory management. The approach taken follows the model in U.S. patent application Ser. No. 10/627,799. Common-sense reasoning is divided into several (ten or so) domains, such as time, location, relationships, and inventory. Each domain has a number of problems associated with it: in the time domain, evaluating a time expression such as “three days before my vacation” to produce an actual date, such as “Jun. 22, 2003,” for example, or in the inventory domain, determining when to re-order an item for which you maintain an inventory. For each problem, there are operations to help deal with the problem.

This approach to common-sense reasoning does not require a complete implementation, or even a complete specification, to be useful. Rather than attempting to duplicate the brain's function, or even that portion of the brain's function that can be considered common-sense reasoning, it simply provides a way to organize reasoning algorithms that can be defined, and that the invention can use. Other domains might be identified, additional problems might be defined, and other operations might be developed over time without affecting the overall structure.

The core of the device is the management module 112. This module is particularly important, and particularly complex, because the users of the device are generally expected to be passive: most conversations are, ideally, initiated by the device, rather than by the user. The data structures and methods used in this module are discussed in more detail below; the sub-modules shown in FIG. 1 give an idea of the range of functionality supported.

Scheduling 114 and event management 116 are closely related functions, and central to the present invention's functioning. The management module operates, as discussed below, by attempting to achieve goals that are either coded into it or generated from data in the profile. For managing diabetes, it has overall goals (among others) of recording the user's diet, exercise, and blood glucose levels. For the user's diet, it maintains a schedule of usual mealtimes; at each mealtime, it initiates a conversation through managed conversation 134 to find out what the user ate at that specific meal. The existence of this goal also allows the device to interpret and record the information if it comes in unprompted, or late. In addition, scheduling 114 and event management 116 are responsible for managing interactions with the outside world, through the care provider interface 150, device interfaces 152, and the network interface 160, all discussed below.

Inventory management 120 of course makes extensive use of the operations in the inventory common-sense reasoning domain 130. The inventories to be managed vary depending on the device's application; for diabetes, there are supplies for one's blood glucose monitor, typically test strips, lancets, and batteries, as well as prescriptions, and perhaps syringes. For each of these, as discussed below, management involves tracking what's on hand, the rate of consumption, and the time required to get a new supply.

The performance rating module 118 helps ensure the continued use of the device. A user who seems to be following advice (with respect to diet and exercise, for example), and who provides information as requested (blood glucose readings) will be rewarded in various ways. In some embodiments, targeted at younger users, the reward might be access to a new computer game; in others, the reward might be a discount at a pharmacy, or a discount on one's health insurance. The rewards must be interesting and valuable enough to retain the user's interest; they must also be given only when the user is objectively succeeding in managing his illness. In the case of diabetes, for example, the hemoglobin A1c test, which is performed every few months by a care provider, is taken as a measure of how well the disease is being controlled; the user can't make up good-sounding numbers as he can with data entered manually into devices. In cases where the invention is applied to diabetes, the combination of good behavior as recorded by the invention, and good behavior as documented by the A1c test, might be required to receive some rewards, particularly those with monetary as opposed to emotional value. Similarly, an application of the invention to weight control can limit rewards to those cases where the targeted weight loss has been achieved, rather than giving rewards based on the user's reported diet and exercise.

The other side of performance rating involves modifying the device's behavior to be as non-intrusive as possible. For example, if a user consistently fails to enter dietary information, but is otherwise taking advantage of the device, preferred embodiments will stop asking such questions, or at least ask them less frequently; irritating the user in this way can lead to his discarding the device, which may be doing some good even if the user is not following all aspects of his treatment plan. Similarly, if the user always disables voice output on the device when it's turned on, the device should learn to do that automatically. In all of these cases, the goal is to encourage and reward good behavior, without crossing the fine line between productive nagging and being permanently ignored.

The disease management module 122 contains code specific to the problem of disease management in general, and specific to the particular disease being managed. The boundary between this module and the knowledge base 102 (in particular the disease knowledge base 110) is flexible: putting the expertise in code results in a faster system that in the short run is easier to develop, where storing it as knowledge makes the system more transparent and easier to upgrade.

Some embodiments of the invention provide a network interface 160 to allow access to the Internet or other computer networks. Depending on the embodiment, this may take the form of a telephone modem, a cellular telephone interface, a Bluetooth wireless connection, or any of several other possibilities. In all cases, the management module 112 can use this interface to obtain information on the user's behalf, to send information to the user's care providers from outside the office, or to perform functions such as renewing prescriptions online when those services are available. The management module does not assume the availability of such a connection in any case: with current technology, maintaining other than an intermittent network connection from a mobile device is physically difficult and rather expensive. Although we assume that this will change, we want the device to be useful even when it's completely out of range of any network. The scheduling 114 and event management 116 modules can cause tasks to be executed when a connection is available (at a WiFi hot spot, or during off-peak hours for a cell phone connection, for example), and prioritize them so the most important are executed first—if the connection is transient, the device will try to maximize the gain from the times when it has one.

In some embodiments, the network interface 160 is implemented as, or includes, a voice telephone connection. This allows interaction with automated voice response and DTMF-driven systems, and gives the device the ability to communicate directly with humans (the user or a care provider) when necessary.

Communication with the user is mediated by the managed conversation module 134. As a practical matter, embodiments of the present invention that are pocket portable do not have the computational power to understand arbitrary spoken input from the user with a reasonable degree of responsiveness. Instead, whenever it can, the device takes the initiative in conversation with the user, though as described later it can have several independent conversations in progress at one time. What this means is that the device will request information from the user (“What did you have for lunch?”), rather than waiting for the user to say, “Today I had roast turkey on whole wheat, with cranberry sauce. Oh yeah, and an orange.” A question posed by the device establishes a context for interpreting the user's answer, if spoken, that makes understanding it much easier.

Preferred embodiments of the device accept spoken input, and input through a graphical user interface. For the user to enter data into the GUI, he must either respond to the current form, or navigate to a form that will accept the data he wishes to enter. In either case, the context is completely unambiguous, which is not true of speech input. Although some pocket portable devices also accept handwritten input in several forms, preferred embodiments of the device do not attempt to handle arbitrary written commands: the “smart phones” that provide the hardware basis for the device most often do not accept such input. In any case handwritten input has many of the same problems as spoken input—ambiguous context, the inherent difficulty of understanding arbitrary English, and the difficulty of producing an accurate transcription—without the speed and convenience that speech provides.

As shown in FIG. 1, managed conversation has several components. When information is requested, the management module 112 presents it to managed conversation 134; in preferred embodiments, the information request is kept in the knowledge base 102, as a detail structure described in U.S. patent application Ser. No. 10/627,799. Preferred embodiments of the present invention allow the user to interact either via speech or via a graphical user interface; it follows that the information request may be spoken by the device (if the user has not disabled speech output), and may also be displayed on the device's screen. As discussed below, differences between spoken communication and communication through a GUI must be recognized; although the two modes co-exist, they should not in general be entirely synchronized. The language generation module 136 is used to support both modes; for output to the GUI, it will tend to include more levels of detail; for speech output it will be as terse as possible, while giving an audible cue that more information is available if desired.

In general, assuming the device has competent speech recognition 146, it will be easier for the user to answer a question orally than to answer it through the limited GUI of preferred embodiments. If the question is, “What did you have for lunch?” it's easier for the user to say, “Ham and cheese on rye” than to enter that on a device that typically will not have a keyboard, or at best just a telephone keypad. The options are either handwriting, which is relatively slow and difficult for someone who might be partially disabled either by age or the side effects of a chronic disease, or selecting from lists of options. Given the number of things one might eat for lunch, navigating any such list will be difficult at best. Accepting the answer via the GUI requires intelligent dialog generation 140. As discussed below, this uses information contained in the knowledge base 102 to ease the user's data entry problem: for example, although there's a long list of possible lunches, many people consistently choose from a small subset of those possibilities, something that will become apparent in the knowledge base fairly quickly. Beyond that, GUI generation 140 must limit the options displayed at any given time, because the physical device by definition has a small screen. Further, many smart phones only provide a numerical keypad for input to the GUI, so a common usage is to display no more than nine choices on a single screen, with the “0” key used to get more. Embodiments of the device on hardware that supports touch screens permit selections to be made with the user's fingertip rather than with the stylus conventionally used on PDAs—but this requires relatively large buttons on a small display, again restricting the number of options that can be displayed on one screen.

In embodiments of the device that allow natural language input, when the user enters some, either via speech 146 or via handwriting on the GUI 144, the device must interpret that via the natural language parsing logic 138. In practice, contemporary speech recognition software is much more effective in conjunction with a natural language parser, which can assist in deciding which of several possible interpretations of an input makes sense, so the connection between language parsing 138 and speech in 146 is closer than shown in FIG. 1. Preferred embodiments, which accept handwritten input only in the context of entering data into a GUI form, do not support full natural language input; speech recognition software is much more effective, particularly on small devices, with a restricted grammar that constrains the set of legal utterances. Such a grammar can be constructed to allow reasonably natural sentences without pretending to handle full natural language. It is more important, especially on a small device, that the speech recognition software handle the needed vocabulary; an embodiment of the present invention applied to either weight control or diabetes requires an extensive set of foods, for example, and the ability for the user at least to define common meals, if not to add new foods. In either case, the vocabulary has to be large and extensible; on a small device, the necessary compromise is to limit acceptable input syntaxes.

As mentioned above, and as discussed in more detail below, the device permits several conversational threads to coexist. However, at any given instant only one of those threads can have the focus, in the sense that its question is the one displayed on the GUI 144. For example, the device may ask the user to enter a blood glucose reading, and later, but before the user has done so, it may ask what the user had for lunch, thus making two threads active. The focus module 142 decides which thread should be current, based on criteria such as the urgency of the data requested (or of the task, if the device is reminding the user to refill a prescription for which he just took the last pill), how time-sensitive it is, whether it matters if the user never answers the question (if the user misses a blood glucose reading or entering a meal, it's undesirable but not fatal), and so on.

The focus module 142 interacts with language parsing 138 and speech input 146 to set the device's expectations for spoken input. Standard speech recognition software, such as that included in preferred embodiments, provides methods for changing its language model to reflect the context, and effective use of those methods greatly increases accuracy. Preferred embodiments of the invention use these methods extensively. If the current conversational focus is a dialog that is requesting a number, such as the user's weight, or a blood glucose reading, the invention will enable a part of the language model that allows the recognition of numbers by themselves. Otherwise, that section of the model will be disabled, while leaving another section that allows utterances such as, “My weight is 156 pounds.” Similarly, if the user says, “For breakfast, I had <some food>,” the language model will of course be configured to allow foods that have been identified in the profile as breakfast foods; of course two users may have very different sets of breakfast foods in their profiles. But if the user says, with no context, “I ate <some food>,” the device will find recognition much more difficult, because the set of all possible foods is much larger than the set of all possible breakfast foods. In such cases, preferred embodiments of the invention will take several approaches to producing an acceptable result. First, the device knows what time it is, and what meal is nearest, so it can adjust the language model to reflect that—“I ate <some food>” at 12:30 most likely is referring to lunch. If that adjustment does not produce something that the speech software recognized with a sufficient level of confidence, then we can take advantage of the ability of the device to save a recording of the user's utterance, and run it through the speech recognition code again after making changes in the language model: try a different meal entirely, or broaden the list of acceptable foods to include breakfast as well as lunch, or if necessary all foods. In addition, speech recognition software typically generates a set of possible interpretations of an utterance, with some kind of confidence ranking; preferred embodiments of the invention may process several members of the “N-best” set using information from the profile to decide which is really most likely, based on things like the foods most frequently eaten by the user, the exercises he regularly performs, and so on. In this way, the language model can be made more expansive, while the device can still take advantage of its detailed user knowledge to obtain the most likely interpretation of an utterance.

As discussed below, the invention has the ability to modify its behavior in significant ways based on the user's history; in speech recognition, it uses that ability to decide exactly what course is most likely to lead to correct recognition of the user's utterance. If it sees that the user frequently doesn't enter the details of his dinner until the following morning, for example, it might modify the language model to prefer dinner foods for “I ate <some food>” when it's said in the morning; similarly, it can initially limit the set of foods handed to the speech recognition software to those that the user eats frequently, at a particular meal or at any meal, rather than to the set of all foods in the profile. In this way, the structure of the profile, and the device's knowledge of the user's typical behavior, permit significant enhancements in its ability to recognize speech.

It will be understood that asking the speech recognition software to try again on an utterance will slow the device's response to the user's speech, perhaps noticeably. In such cases, preferred embodiments may choose to report to the user that the form of language he used was difficult to understand, and suggest an equivalent that would be easier. Although the user will speak to the device using natural phrases, it is not expected that the device will be able to recognize unconstrained natural language utterances. Instead, it will recognize utterances from a limited space defined by the language model. Ideally, the model will be sufficiently expansive that the user can comfortably speak to the device without straying outside the set of utterances recognized by the language model, but on some devices, with less capable speech recognition software, it would be acceptable to specify in the documentation a very limited set of spoken inputs that the device will recognize. Thus, some embodiments might document that the way to enter a meal is to say, “For <some meal>, I ate <some food appropriate to that meal>,” and that no other form will work; with more capable software and hardware, the limitations could be made less obvious, and the language model much more flexible.

Preferred embodiments of the invention include the ability to manage monitoring devices, using the device interface module 152. Depending on the disease being managed, such devices may include: blood glucose monitors, many of which already support connection to a computer; heart monitors; accelerometers (to determine level of physical activity); scales; and so on. If the data from a monitor is important, and can't be obtained automatically, then the device will prompt the user to enter it, but wherever possible the device will directly query the monitor and record the data, thus removing a source of both inconvenience and error. In the case of a blood glucose monitor, the user might be prompted to draw some blood for testing, but the device would handle transferring the current level from the monitor once the user confirmed that the test was complete. The management module 112, as discussed below, identifies appropriate times to request the information, and determines, based on knowledge about what devices the user owns, whether it's available without manual intervention.

Finally, the care provider interface 150 provides a facility for the user's care providers to obtain needed information from the device, and to update the medical knowledge or the treatment plan. Some embodiments, subject to privacy and security constraints and network availability, can provide information to the care provider automatically, via email or web services, but others provide it only in the provider's office, by using a short-range network connection such as Bluetooth, or by using a cable to a machine in the office. In either case, the provider interface 150 must deal with the appropriate communication protocols, as well as limiting access to that portion of the knowledge base relevant to the provider: a dietitian should not generally enter new prescription information, and no provider should see personal information that some embodiments permit users to manage along with information about their disease.

Profile

The knowledge base 102, also called the “profile,” is, as discussed above, basically structured as described in U.S. patent application Ser. No. 10/627,799. However, enhancements and design changes are required to support the present invention, in the areas of class structure, performance, application deployment, and reliability. We'll cover each in turn, after summarizing the basic structure of U.S. patent application Ser. No. 10/627,799.

As described in U.S. patent application Ser. No. 10/627,799, the profile is a tree structure containing details, where any given detail has a single parent, a class, optionally a value, and any number of sub-details (the detail at the root of the tree of course has no parent). Class definitions are represented as details in the profile tree; the sub-details of a class definition that are themselves class definitions represent subclasses of their parent.

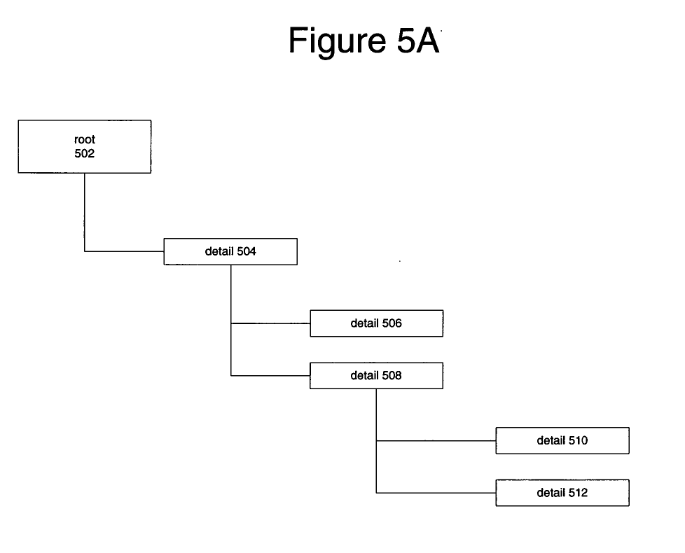

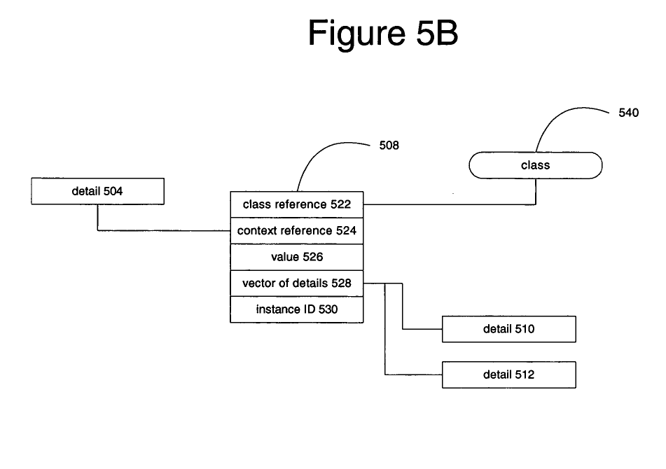

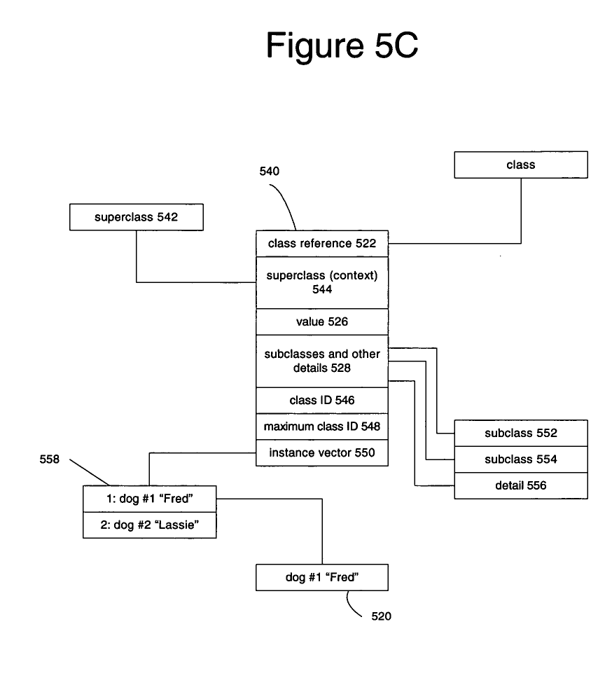

FIG. 5 illustrates the memory structures used to represent the profile in the preferred embodiment of the invention. In FIG. 5A, the root detail 502 has a single sub-detail (child) 504, which in turn has two children 506 and 508, and so on. FIG. 5B shows the memory structure for an instance, that is, a detail that is not a class, 508. The detail structure contains: a class reference 522, which is a reference to the class 540 shown in FIG. 5C; a context (parent) reference 524, a reference to the detail 504; a value 526, a vector of children 528, containing references to the details 510 and 512, and a possibly unspecified instance index 530.

FIG. 5C shows the memory structure for the class detail 540. Because it's a detail, it has a class reference 522; its context reference 544 is (except for the root of the class tree) its superclass. For instance details, the value reference 526 is largely unconstrained; for class details, it is part of the class's definition, and, as described in U.S. patent application Ser. No. 10/627,799, is quite limited. The vector of children 528 for a class can contain both other classes, subclasses of the current class, and instance details that further describe the class: a typical instance, for example. Where the instance detail has an instance index 530, a class detail has a class index 546, used to speed subclass tests and to control sorting of detail vectors. In addition to these elements, which correspond one-to-one to the elements of an instance detail, class details have a maximum class index 548, containing the class index of the highest-numbered subclass of this class, and a possibly null instance vector reference 550, used in conjunction with the instance index 530 to provide a way to identify specific instance details: the combination of class name and instance index is guaranteed to be unique. In this case, there are two references to numbered instances in the vector 558, the first of which is the detail 520.

Profile Class Structure

The profile as defined in U.S. patent application Ser. No. 10/627,799 explicitly does not provide mechanisms for enumerating instances of particular classes, nor for finding, short of a recursive descent of part of the class tree, the subclasses of a particular class. Although it is possible to construct a perfectly adequate system without direct support for these features, in preferred embodiments of the present invention that support is provided. Doing so makes required knowledge much easier to find, as we'll show in the illustrations.

Rather than providing either feature for every class, which would create far too much unnecessary structure, we use the descriptor feature of U.S. patent application Ser. No. 10/627,799 to identify classes for which additional information should be recorded. For classes where the application designer expects to enumerate all instances, the descriptors “records all instances” and “records direct instances” are defined. The distinction between the two descriptors is simple: “records direct instances” means that the class will record instances of itself, but not of its subclasses; “records all instances” means that the class will record instances of itself and of its subclasses.

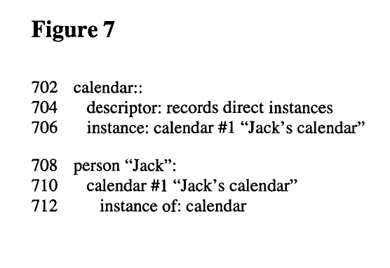

As shown in FIG. 7, the calendar class used in the present invention is described as “records direct instances.” The ability to find all calendar objects is important, since calendars are central to the management function 112. The user's calendar is constantly in use, but there may be additional calendars associated with the network interface, the care provider interface, or various device interfaces, and management 112 must examine all of them when it's looking for actions to perform.

The descriptor 704 informs the profile loader (KAP in U.S. patent application Ser. No. 10/627,799) and profile management software that any instance of the calendar class 702 should be recorded. The creation or loading of such an instance 710 causes the creation (if it doesn't already exist) of an “instance” detail 706, whose value is a reference to the new instance; simultaneously, the system will create an “instance of” detail 712, whose value is the class. Deletion of the calendar object 710 will, using mechanisms defined in U.S. patent application Ser. No. 10/627,799, automatically cause deletion of the corresponding instance detail 706. The profile management software accessible to any device using an embodiment of U.S. patent application Ser. No. 10/627,799 makes it easy to enumerate all the instance details of the calendar class 702, thus providing a current list of all the calendars in the system. It is up to the application designer to ensure that the device doesn't process irrelevant calendar instances, by providing them with appropriate descriptors, or by providing all interesting calendar instances with appropriate descriptors.

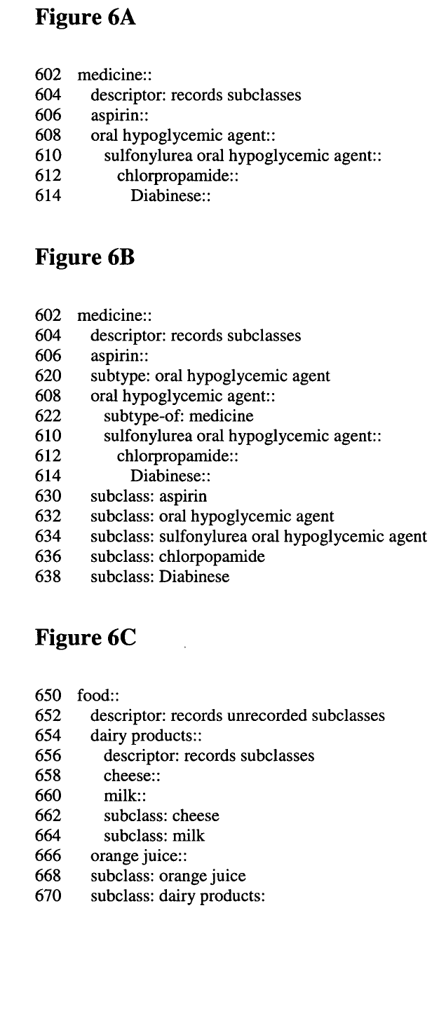

The same problem, in a considerably more complex form, comes up with enumerating all the subclasses of a particular class. As described in U.S. patent application Ser. No. 10/627,799, there are two kinds of classes: word classes, which are named by a single English word, and qualified classes, which are named by an English phrase, or by a variant of a single word—thus the class named “cars” is a qualified subclass of the class “car,” named by the plural form of the word. A word class is a subclass of its parent; in FIG. 6A, the class aspirin 606 is a subclass of medicine 602, because aspirin is placed as a detail of medicine.

For qualified classes, the superclass-subclass relationship is more complex. The qualified class “oral hypoglycemic agent” 608 is placed as a subclass of medicine 602, but will be represented in the class tree as a subclass of “agent,” because qualified classes are added to the class tree based on the parsing of the English phrases that name them. In fact, qualified classes needn't be explicitly defined to be added to the class tree correctly: a simple reference to the class “oral hypoglycemic agent” is enough to create and place a class detail for it (as a subclass of agent), if one doesn't already exist, and if the words that make up the phrase are known to the system.

There are many cases in preferred embodiments of the present invention where we need to present the user with a list containing every member, or almost every member, of a specific subset of the class tree: every prescription medicine, every breakfast food, and so on. The organization and presentation of such a list is a separate problem, discussed below, but the structure of the class tree makes obtaining it rather complicated. In particular, returning to FIG. 6A, because “oral hypoglycemic agent” 608 is not properly a subclass of “medicine” 602, a simple descent of the class tree starting at medicine 602 will not find it, nor will it find the actual prescription drug Diabinese 614. It is possible to keep a list of drugs as a separate object in the knowledge base, but this has the disadvantage that it makes keeping the knowledge base current more difficult: adding a drug requires that it be added in two locations. Again, it would be possible to tag each drug in some way, eliminating that problem, but then obtaining a complete list of drugs requires a search of the entire class tree, rather than of the relatively small part of it devoted to medicines.

Preferred embodiments of the invention provide two forms of support for this. During profile loading, when a qualified class is placed as a subclass of a class that will, in the class tree, not be its ancestor, the loader creates a “subtype-of” detail in the qualified class, with the placement context as its value, and a “subtype” detail in the placement context, with the qualified class as its value. FIG. 6B shows the results of this: the subtype detail 620 and the subtype-of detail 622 maintain a link between oral hypoglycemic agent 608 and medicine 602, even though oral hypoglycemic agent 608 is not a subclass of medicine 602.

This allows applications to navigate in the class tree as entered by the profile developer, as well as in the class tree built during profile loading. However, it does still require tree walking. For cases where the invention requires a list of all known medicines or all known foods, we provide a simpler mechanism. A class with the “records subclasses” descriptor, 604 in FIGS. 6A and 6B, is given “subclass” details for every class that is a subclass in the class tree, for every class that was placed as a subclass in the profile input, and for every subclass of those classes. In FIG. 6B, this produces the subclass details 630, 632, 634, 636, and 638, each of which has as its value one of the descendants of the class medicine 602.

Finally, as shown in FIG. 6C, there are cases where the level of recording provided by “records subclasses” is excessive. In this case, the class food 650 has a subclass dairy products 654. The profile designer wants a list of all the subclasses of dairy products 654, because that allows the device to present a shorter top-level list to the user: rather than including all dairy products, it can include “dairy products,” and show the sub-list if the user desires. If food 650 has a “records subclasses” descriptor, it will get subclass details for dairy products 654 and for all of the subclasses of dairy products. Instead, it has a “records unrecorded subclasses” descriptor 652; this produces subclass details 668 and 670, corresponding to the subclasses dairy products 654 and orange juice 666. Dairy products 654, which records its subclasses, gets subclass details 662 and 664 for cheese 658 and milk 660.

Profile Performance

The “KAL” format of the profile described in U.S. patent application Ser. No. 10/627,799, and used in examples here, has several advantages. It is completely general; it is easy for humans to read and change; it is relatively easy to break a profile, which is potentially quite large, into manageable chunks.

However, as with any compilation process, loading a profile in that format is rather time-consuming, particularly on the hardware devices used by preferred embodiments of the present invention. In addition to requiring a substantial amount of processing, loading the profile from this format uses a lot of memory for temporary structures; on a device such as a smart phone, this will often mean that a profile that would fit into memory once it was loaded, can't be loaded; use of the KAL format unnecessarily limits the size of the profile, and therefore the flexibility of the device.

Preferred embodiments of the present invention therefore use a more compact, faster to load stored form of the profile that is less readable for humans. They retain the ability to load the KAL format used in examples here, and to store a modified version of the profile in either KAL format or the “fast” format. For the treatment of a chronic disease such as diabetes, the profile must be customized before it will be of any help to the user; someone has to provide it with at least the user's treatment plan and goals, and perhaps other information about the user's preferences and habits. Delivery of the preferred embodiment of this invention is accomplished by having the user's care provider fill out a form, preferably electronic, with the required information; this can be transformed into a profile customized for the user, loaded from KAL format on a fast machine, then saved into fast format for installation on the user's device. On the device, subsequent saves, as required, will be in fast format.

Preferred embodiments of the invention also generate speech input-related files at the same time. Modem speech recognition systems, such as those used in the speech input module 146, require a grammar describing acceptable inputs if they are to perform well without substantial user-specific configuration, especially on small devices such as PDAs or smart cell phones. Much of the information required for the grammar here is contained in the profile: foods, prescription drugs, exercises, and so on. It follows that it is sensible to generate the speech grammar offline, at product configuration time, rather than doing so each time the product is started. There may be changes required as the product runs: the user may add new foods, or require information about drugs that were not originally in the profile; the speech recognition systems used allow dynamic additions to an existing grammar to support this, something that can be handled as changes are made in the profile, or as profile journal files are processed during startup.

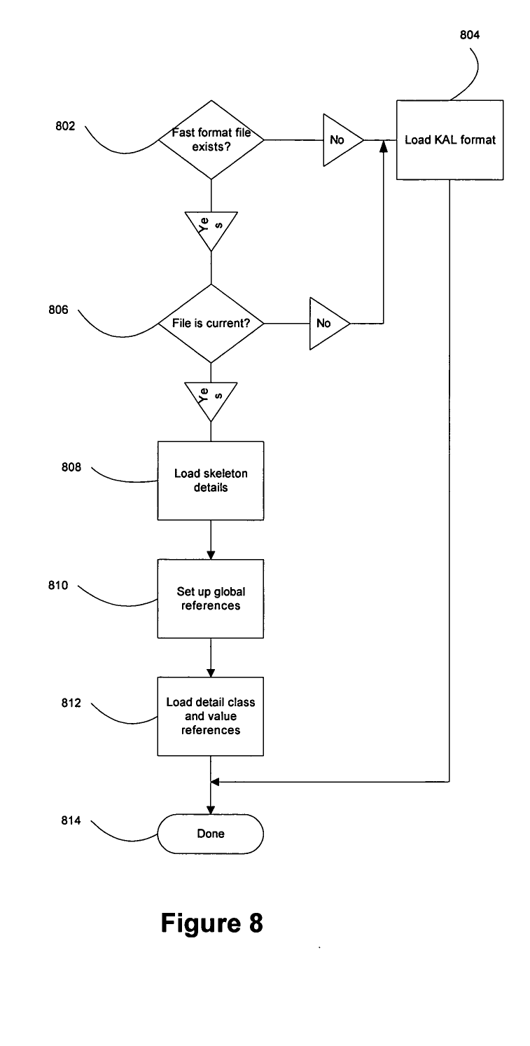

Preferred embodiments load the fast format profile according to the flowchart of FIG. 8. At 802, the loader looks for a fast format version of the profile it has been asked to load; if one doesn't exist, it proceeds to 804, where the KAL format profile is loaded. If the fast format file exists, then at 806 the loader examines the list of files used to generate the fast format file, which is stored in the file header, to determine whether the fast format file is current with respect to its sources. If all of the source files exist, and if one or more of them are more recent than the fast format file, execution again continues at 804.

Otherwise, at 808, the loader reads in detail “skeletons.” This allows it to build objects in memory for each detail in the profile, and to create the appropriate context/detail relationships among them, without assigning class or value references to any of them. By assuming that all class and value references are forward references, we can greatly simplify the procedure for loading the profile. Refer to FIG. 5 for the structures that are constructed here.

Next, at 810, the loader identifies certain distinguished details and classes that are required for proper execution of the rest of the code, such as the class “class,” and the root detail of the profile. Given the root of the profile, all of these could be identified by walking the tree, but it is more efficient to store references in the fast format file.

Finally, at 812, the entire profile tree exists. It is therefore possible to load class references for each detail, since a class reference is just a reference to another detail, and detail values. Detail values may be numbers or strings, which could be handled elsewhere, but they may also be references to other details; again, for simplicity, we load all values at once, even those that could have been loaded earlier.

The fast format profile contains all classes and details that existed when it was saved, including automatically-generated back references and qualified classes. It therefore requires little or no additional processing before the software can begin execution.

Deployment

As discussed earlier, the profile contains a lot of relatively static knowledge related to language in general, treatment of a specific disease, and so on. This knowledge will be common to all users of the invention, or at least to all users who have the same disease. In addition, the profile has information that is specific to a particular user: his treatment plan and goals, his history, and so on. A large part of the user-specific part of the profile is also static—as a rule, one does not get a new prescription every week—but it is not shared with any other user.

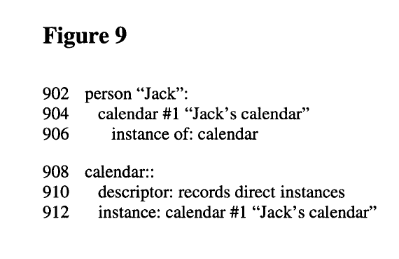

Initial configuration of a device for a particular user involves entry of the user-specific data, preferably via the Internet, and the generation of a profile for that user's device. Over time, the user-specific portion of the profile will change: the treatment plan may change, more of the user's habits and preferences will be entered or identified, and records of the user's compliance with his treatment plan will accumulate. Although the changes are user-specific, and we can usefully describe a user-specific section of the profile, the automatic creation of back references described in U.S. patent application Ser. No. 10/627,799 can lead to user-specific changes in otherwise static, common sections of the profile. In FIG. 9, the person detail 902 has a calendar detail 904. Because the calendar class 908 has the records direct instances descriptor 910, it will have an instance detail 912 whose value is a reference to the calendar detail 904. The calendar class itself is clearly part of the static, common section of the profile; the instance detail 912, though, is very much user-specific.

Preferred embodiments of this invention will require that software upgrades be provided from time to time, and many of these upgrades will involve changes in the profile. It is important that such changes, when applied, not result in the loss of the user-specific data that is also stored in the profile. Embodiments of the current invention intended for commercial use will therefore require a profile storage format considerably more complex than that described in the previous section. Although the profile remains a strict tree, it is necessary to identify those sections that contain user-specific data, and, within sections that do not, those details that are back references to user-specific data. The section not containing user data is “upgradeable”; the section containing user data is “persistent” with respect to upgrades.

To allow software upgrades, some embodiments will store the profile as two separate files, using a file format similar to that described in the previous section. The upgradeable section contains only static data, and may define specific entry points where persistent data can be attached to the profile tree. The persistent section will contain user-specific data, and may also have the representation of back references to be created in the upgradeable section: although it is possible, as described in U.S. patent application Ser. No. 10/627,799, to create the back references automatically, startup will be significantly faster if that can be avoided. There are many suitable file formats that could be used here; it will be recognized that the problem is like that of linking together object files produced by a compiler for a conventional programming language.

Reliability

As with any system where data is accumulated over a long period of time, the present invention must ensure that information is not lost due to hardware or software failures. As the system runs, any data that needs to be saved will be recorded in the profile. Although it is in principle possible to save the entire profile every time it's changed, doing so could significantly slow the device down, and requires enough file storage to maintain two full copies of the profile.

Instead, preferred embodiments use a journaling mechanism similar to those used by standard databases. Each profile change is logged as it occurs to a journal file, which is processed after loading the main profile files described above. A successful complete save of the profile of course obsoletes any existing journals.

In preferred embodiments, a change made to a detail (that is, setting its value, adding a new child detail, and so on) requires that we be able to refer to it in the journal file. The mechanism provided for this, as described in U.S. patent application Ser. No. 10/627,799, is the assignment of a class-relative instance ID 530 to the detail: the combination of class and instance ID, for those details that have one, is a unique identifier. But the assignment of an instance ID is itself something that has to be recorded in the journal, and therefore requires the ability to identify the detail to which the instance ID is being assigned. The use of instance IDs is intended for resolving references in a saved profile; particularly in KAL format, the order of child details may not be canonical, due for example to hand editing.

There are two options here. Some embodiments of the invention simply assign an instance ID to every instance detail—that is, to every detail that doesn't represent a class. This has the disadvantage that it uses more space during execution, solely for journaling. In the preferred embodiment, we take advantage of the canonical ordering of details described in U.S. patent application Ser. No. 10/627,799. All of the child details of a given detail are kept in a canonical ordering determined by their classes and, within a class, the order of creation. A journal file starts from a known state of the profile, so any detail can be uniquely identified as the nth child of a particular parent. The parent can be identified in the same way, recursively, until we reach either a class detail or a detail that has an instance ID already assigned. The identification may only be valid for an instant—a detail might get a sibling that precedes it in the canonical ordering, requiring that it subsequently be referenced as the n+1 detail of its parent, but processing of the journal file will essentially replay all profile changes in order, so the state of the profile when loading a particular change from the journal will exactly match the state of the profile when that change was saved to the journal.

Management

In the exemplary architecture of FIG. 1, the management module 112 drives, directly or indirectly, most of the activity in the invention. As discussed above, the scheduling 114 and event management 116 modules are central: in preferred embodiments, the device takes the initiative in its interactions with the user as much as possible. It does so by maintaining a schedule of events, many of which will cause it to initiate a conversation with the user when they become current.

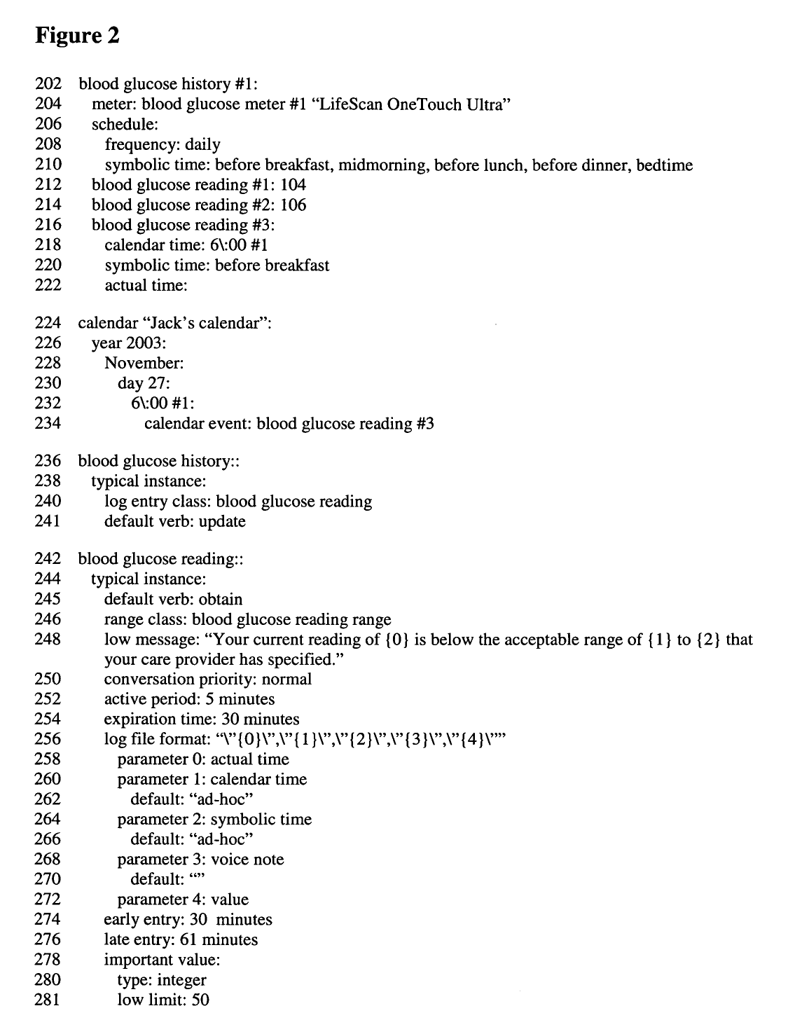

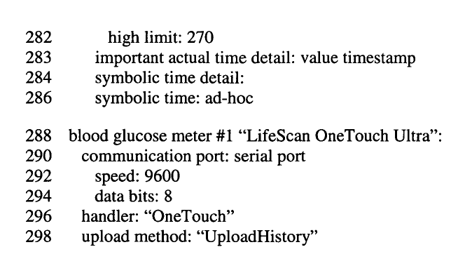

FIG. 2 is an exemplary profile 102 structure used to deal with schedules and events, in the KAL notation of U.S. patent application Ser. No. 10/627,799. In the management of diabetes, it's important to track the patient's blood glucose level; knowledge of the current value is required in many cases to compute appropriate doses of some diabetes medications, and a longer-term record is useful to the care provider in determining whether the disease is being managed properly. The preferred embodiments of the invention, as applied to diabetes, would therefore have as a high-level goal the maintenance of the user's blood glucose history 202.

This detail has several sub-details to guide the scheduling 114 and event management 116 modules in collecting data from the user. The schedule detail 206 gives approximate times at which the information should be obtained: before each meal, before bedtime, and midmorning. The evaluation of these time expressions is a problem in the time common-sense reasoning domain 126; it depends on information in the profile 102 regarding normal mealtimes, as well as the typical (or explicit) schedule for the specific user.

In preferred embodiments of the invention, typical instance details are particularly important. In the exemplary profile of FIG. 2, the blood glucose history class 236 has a typical instance detail 238 that provides the link between instances of blood glucose history and the class of the readings that are added to the history: the log entry class detail 240 has as its value the class of the readings for a blood glucose history. Some embodiments might generate the reading class algorithmically, by substituting “reading” for “history” in the class name, but a link that is explicitly declared makes it easier for humans to understand the profile, and provides more flexibility to the profile developer.

The user's typical schedule can be entered directly, either through the user interface 160 or by direct editing of the profile 102, but can also be deduced. As we'll discuss, the history of blood glucose readings 202 will reside in the patient data 108, and will include the times at which the readings were actually entered; the system can examine all of the “before lunch” readings to decide roughly when the user eats (which might easily vary in a predictable way based on the day of the week, whether it's a holiday, and so on). Certain embodiments of the invention may give the user the ability to manage his own schedule using the device, which would allow those embodiments to adjust the reading times on days when it could be determined that the user would be eating at an unusual time.

The general scheduling software 114, having decided that the blood glucose history 202 will need attention “before breakfast,” and having determined what that means, next needs to find something to provide that attention. The meter sub-detail 204 has as its value the profile entry for the user's blood glucose monitor 288. The scheduling software will add a calendar event detail 234 to the monitor's calendar 224, in the detail 232 for the time at which the reading should be taken. The calendar event 234 has as its value a specific reading 216, for which no value has as yet been obtained; the exemplary profile of FIG. 2 shows the two previous readings 212 and 214, with values 104 and 106, respectively. (The readings 212 and 214 will in practice have additional details similar to those provided for the reading 216. They are omitted here to save space.)

It will be apparent that there are many ways to trigger such events. In preferred embodiments, events such as blood glucose readings are added to the user's calendar about a day in advance; it's easy to add future events of the same type while processing an event. This can help the user plan his schedule for the next day. Other embodiments might populate the calendar much further in advance, which assists planning but makes it more difficult to adjust to changes in the user's habits over time. It would be possible to produce similar behavior without direct use of the user's calendar as shown in FIG. 2: it is enough to be able to interpret phrases such as “before breakfast” in a reasonable way, and to find events whose sets of symbolic times include before breakfast. Doing so requires more specialized computation more often; putting an event on the user's calendar at a computed time, whether the event is specific to blood glucose readings or represents a collection of several before breakfast events, means that the device has to answer the question, “When is ‘before breakfast’?” relatively infrequently, rather than asking more frequently, “Should I take the current time to be ‘before breakfast’?”

The scheduling module 114 will ensure that the calendar event 234 for the before breakfast reading of Nov. 27, 2003 exists in advance, and, in preferred embodiments will create a corresponding empty blood glucose reading 216, as discussed below. The event manager 116, taking advantage of its access to all calendars in the system, periodically examines them to determine which events it must tend to next, and when that will be. At that time, it will create a thread for each such event. Although it's possible to use an operating system thread for this, in preferred embodiments the thread is represented as state within the scheduling module. The events being managed do not require the levels of protection and responsiveness that an operating system thread provides, so we can avoid the complexity involved in synchronizing accesses from multiple threads to the profile. The thread for the monitor will be started at the time 232 of the calendar action 234: Nov. 27, 2003 at 6:00 AM.

Because the thread is not an operating system thread, any code executed remains under the control of the event manager. When the thread starts, it will invoke code based on the class of the calendar event's value, which in this case is blood glucose reading 242. The reading itself was initially populated from, and actions regarding it are based on, the typical instance 244 of the blood glucose reading class 242. In the blood glucose reading detail 216, the symbolic time detail 220 was created to correspond to the “symbolic time detail” detail 284; similarly, the actual time detail 222 was created to correspond to the “important actual time detail” detail 283. The rule followed by the preferred embodiment is that details of a class's typical instance detail that are themselves of class “detail”—that is, whose class is a subclass of the class “detail”—will correspond with details of a new instance. The qualifier “important,” as with the “important actual time detail” detail 283, indicates to the event manager that the corresponding actual time detail 222 must have a value for the blood glucose reading detail 216 to be considered complete.

In U.S. patent application Ser. No. 10/627,799, management code was stored as part of the profile. Although this is a very general and flexible solution, it is not practical on the current generation of smart phone devices, which are the target hardware platform for the present invention. If nothing else, the processor speed is such that execution time would be inadequate; in some embodiments of the invention, this is solved by compiling the management code during the loading of the KAL-format profile, and saving the compiled code as part of the binary formats described above. Preferred embodiments instead provide methods for linking between the profile and conventional code libraries shipped separately from the profile. Although this is less flexible and transparent, it provides superior performance, and eliminates the need to build general programming language support into the system.

In preferred embodiments, the decision as to what code to invoke is still based on English expressions—that is, on qualified classes. Referring again to FIG. 2, the typical instance 238 of blood glucose history 236 has a default verb detail 241 whose value is update. This simplifies the representation of complex actions: if the scheduler or event manager encounters an instance of blood glucose history without an associated action, the expression “update blood glucose history” can be assumed. Similarly, the typical instance 244 of blood glucose reading 242 has a default verb detail 245 whose value is obtain: when the event manager encounters the calendar event detail 234, whose value is an instance of blood glucose reading, it will be able to decide that the correct action is to obtain a blood glucose reading.

Other embodiments may use different mechanisms. For example, the calendar event detail 234 might legitimately have as its value “obtain new blood glucose reading for user,” which, given suitable modifications in the profile, can be interpreted in a reasonably straightforward manner. Another obvious possibility is quite difficult to represent in the architecture of U.S. patent application Ser. No. 10/627,799: giving the calendar event 234 the value “obtain blood glucose reading #3” makes some sense in English, but the knowledge architecture forbids the creation of classes qualified by instances, so this would have to be interpreted as an instance of the class “obtain blood glucose reading,” which is not what we intended. The default verb mechanism described here overcomes this limitation.

In preferred embodiments, the code to handle operations of the general class “update reading” is part of the program executable, rather than of the profile. Whether the reading in question is a blood glucose level, the user's weight, or any other value, the code allows for the possibility that there will be a device from which the reading can be obtained directly. In the exemplary profile of FIG. 2, the meter detail 204 of the user's blood glucose history indicates that the user has such a meter, the blood glucose meter 288. The handler detail 298 identifies a code module within the product that implements an interface for obtaining such readings—in effect, a device driver for the meter. Driver parameters that may vary among different versions of the meter and different means of connecting to it are stored in the profile, as for example the communication port detail 292. Should the device driver fail (for example, be unable to connect to the meter), or if there were no meter detail 204, the update reading code would fall back to requesting the information from the user, using a user interface as described below.

The event manager must control other aspects of the conversational thread it has initiated. In the preferred embodiment of the device, it is possible for the user to initiate most possible conversations without waiting for a prompt from the device, either by saying the appropriate things, or by making an appropriate selection through the GUI. In the case of a blood glucose reading, it may be that the user has chosen to perform an unscheduled reading for some reason: perhaps he's not feeling well, or he's running a little early, and wants to supply a normally scheduled reading before its scheduled time. The event manager must be able to decide, in such cases, whether the reading should match an event on the schedule. In the preferred embodiment, the event manager uses the early entry 274 and late entry 276 details of blood glucose reading's typical instance to decide whether a user-initiated reading will match a scheduled reading: if the user enters a reading at 5:15 AM, it will be taken as an ad-hoc reading rather than as the before breakfast reading, because it's more than thirty minutes early. It will be apparent that other methods might be adopted: for example, if the user also enters the details of his breakfast early, then a reading that had previously been identified as ad-hoc might be converted into the pre-breakfast reading.

The two most important functions of the present invention, particularly as applied to the fields such as weight management, or management of a disease such as diabetes, are reminding the user to take certain actions, and recording the user's behavior and providing it to his care providers. The scheduling and event management modules described here provide that ability for many aspects of the user's behavior, not just taking blood glucose readings. A reminder to the user will often take the form of a request to enter the needed data: the blood glucose reading, what one ate for breakfast, what one did for exercise, and so on. With the ability to communicate with appropriate devices, where available, and the ability to run code specific to the type of information required, the general mechanisms described here support a sufficient variety of reminders and logs.

User Interface

The scheduling and event management modules already discussed will generally initiate conversations with the user; the user can also initiate conversations on his own. It is possible that some of these “conversations” will require no further user interaction—for example, that the user will have a blood glucose meter connected, with a reading in memory that's sufficiently recent to be used—but as a general rule the user will be asked to confirm something, to enter some data, to select among a number of options, and so on. Preferred embodiments of the invention have two characteristics that distinguish their user interfaces. First, conversations are almost always modeless: the user can switch to another conversation at any time, as, subject to certain constraints, can the device itself. Second, the device will provide conventional GUI dialogs for displaying information and obtaining input, but will also optionally provide spoken output, and will accept spoken input; the user is free to use either mode at any time.

Preferred embodiments of the device generate as much of the user interface as possible from information stored in the profile. That is, rather than defining a specific dialog for obtaining a blood glucose reading from the GUI, the device will use information in the profile to generate the dialog, determine what constraints might apply to the value being entered, and produce an appropriate confirmation message for the user.

Conversational Focus

The first function of the managed conversation module 134 is to decide which of several potential conversations currently has focus. This is often obvious, of course: when the device is turned on, preferred embodiments display a “home page” dialog that allows the user to select various common actions. There is no other conversation in existence. Similarly, if the user always responds quickly to prompts from the device, there will be a single conversation in addition to the home page dialog, and that will have focus until the user has finished it. In preferred embodiments, the home page dialog is always available, but will always have the lowest priority when focus is being assigned; that is, any conversation initiated by the user, or any conversation initiated because of an event on the user's calendar, will be given focus instead of the home page. Preferred embodiments provide a consistent mechanism, such as a reserved key, to allow the user to give the home page dialog the focus, since it may be the only way for the user to access some functions of the device.

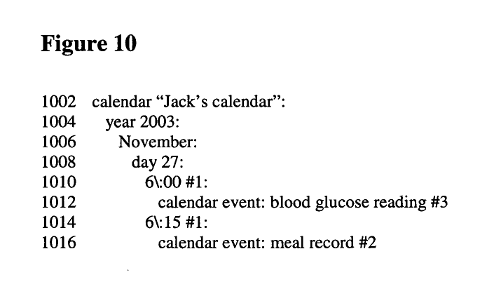

There are many cases where the correct focus will be less obvious. Consider a case where the user has been asked for his before-breakfast blood glucose reading, but has not yet responded. The user's calendar likely has another event, scheduled some time after the before-breakfast reading, to prompt the user: in FIG. 10, the calendar event 1012 will prompt the user for a blood glucose reading at 6 AM, and the calendar event 1016 will prompt the user for the details of his breakfast at 6:15. It would be undesirable for the device to interrupt the user in the middle of entering a blood glucose reading to ask about breakfast; equally, it would be undesirable for the device to avoid asking about breakfast if the user is unwilling or unable to enter a blood glucose reading, but does have breakfast information to provide. Preferred embodiments of the invention try to obtain all the information they can, but have to allow the user to refuse to provide it. Too much persistence has a good chance of persuading the user to abandon this annoying device.

When the event manager starts a thread for the meal entry 1016, it of course wants that thread to have focus. If another conversation is “active,” according to some definition, the new conversation will be forced to wait until its predecessor is either finished or deemed inactive. In the preferred embodiment, the profile contains details that the conversation manager can use to decide when a particular conversation should be marked as inactive. Referring again to FIG. 2, the active period detail 252 of the typical instance 244 of blood glucose reading 242 has as its value the expression “5 minutes.” By convention, the conversation manager will use this to decide when a conversation that is being ignored by the user will become inactive. If the user goes five minutes without making some change in the state of the conversation (entering another digit of the numerical value, for example), then the conversation is inactive; if there is another conversation that wants focus, such as a freshly-created one, the conversation manager at that point will be able to give it. Preferred embodiments of the device also provide an easy way for the user to indicate that he'll get to the current conversation later, by using the Close button on the dialog, or by using an appropriate speech input (“I'll do this later”); in such cases, the conversation becomes inactive immediately, but is not removed from the system. The conversation manager will make it active again after a certain amount of time has passed.

If the currently active conversation is being ignored, and there are no competing conversations, it will remain active until it expires: that is, until the conversation manager has concluded that the user will probably never deal with it. In preferred embodiments, this decision is based on the late entry 261 detail. If enough time has passed that a user-initiated entry of data would be taken as ad-hoc, rather than as the scheduled entry, then the conversation manager will terminate the conversation, noting that the user never responded. Some embodiments may provide a way for the user to decline to answer a question explicitly, or other criteria for expiring a conversation.

Once the current conversation has been closed or put into the background, the conversation manager must choose another conversation to give the focus to. Conceptually, there is a list of active conversations, which can be sorted based on any number of criteria. In preferred embodiments, for example, new conversations (that is, those that have never had focus) will come first, typically followed by those most recently touched by the user, concluding with the home page. For performance reasons, preferred embodiments do not represent running conversations as details in the profile, but of course they could be; doing so would allow the device to completely restore its state were it restarted after a crash, for example.

User Interface Generation

Preferred embodiments of the invention support spoken input and output and conventional GUI input and output more or less interchangeably. The descriptions of the user interface are stored in the profile according to conventions described here; the descriptions have to include enough information to generate a conventional dialog, generate speech, and provide guidance in understanding spoken input as well as validating and storing results obtained from a dialog. Although there is no requirement that the UI descriptions be stored in the profile, doing so gives the device the ability to customize the interface to the current hardware, as well as customizing it to the user's preferences, in a general way. It's possible to provide the same functionality with a UI that's less flexible, or with equally flexible UI descriptions stored in a different manner.

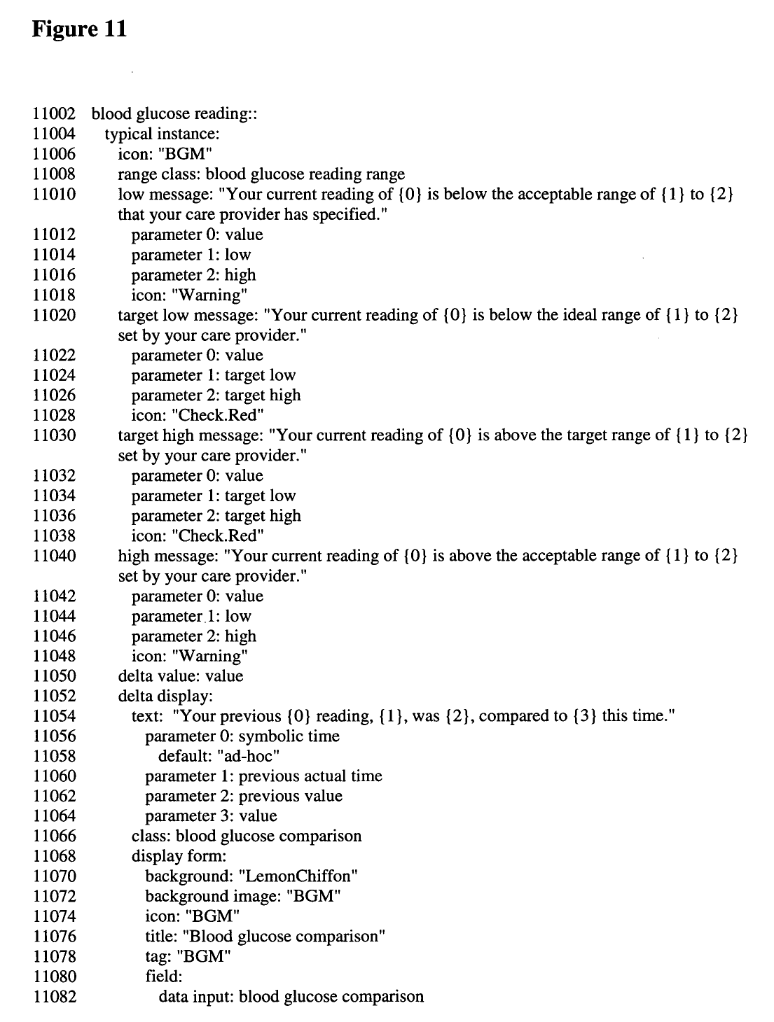

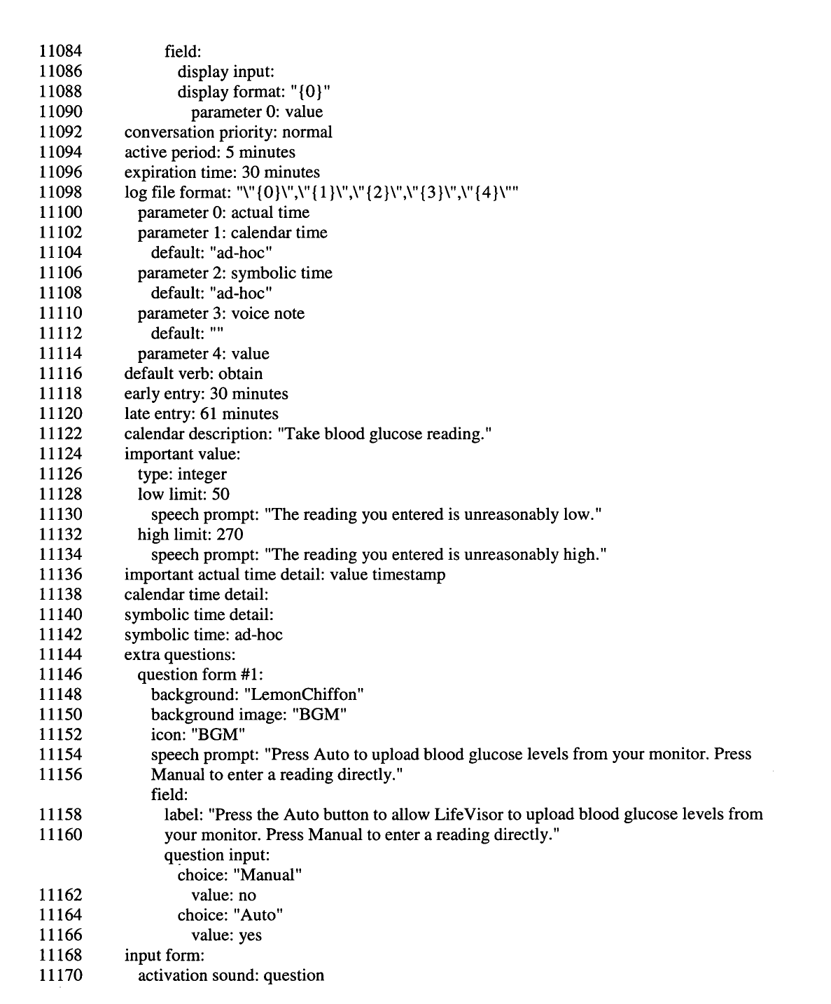

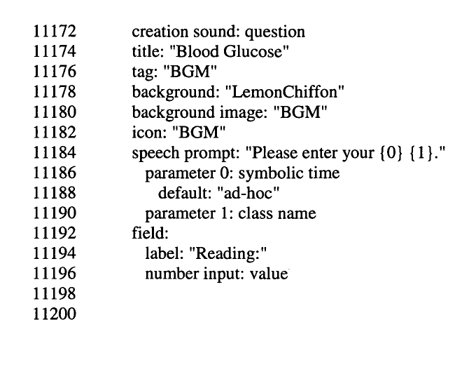

FIG. 11 shows a portion of an exemplary profile containing several UI elements. It is the definition for the blood glucose reading class 11002; instances of this class are used to store blood glucose readings, which may come either from an attached meter or from direct user input. All interesting information is under the typical instance detail 11004 of the class. In preferred embodiments, the code to manage user interactions is outside the profile; it follows that the flow among the various elements described here will not be immediately apparent to someone reading the profile.

Referring to FIG. 2, a related section of the same exemplary profile, the user's blood glucose history detail 202 contains a meter detail 204. If such a detail exists, then, depending on the nature of the particular meter referenced, the management code may be able to query it directly, with no user interaction; with the meter shown here, blood glucose meter 288, it instead has to ask the user whether he wants to enter a value manually or read it from the meter.

By convention, the basic UI elements are of class “form”; to avoid confusion, there is normally exactly one form detail directly contained in the typical instance of a class that accepts user input—in this case, the input form 11172. The form used to ask the user about manual entry of the blood glucose value is question form 11148, contained in the extra questions detail 11146 of the typical instance. The form contains several details that affect its display: a background color 11150, background image 11152, and icon 11154; these represent data that is stored outside the profile, which is ill-suited for the storage of binary data.

The speech prompt 11156 detail of the form provides text that will (if speech output is enabled) be spoken by the device when the form is created. By convention, a text prompt will also be displayed; if there is no text prompt detail, then the speech prompt will be used instead; where it matters, this permits the device to have a more descriptive readable prompt, and a relatively terse audible prompt. It will be apparent that the audible prompt could also be pre-recorded: some embodiments will recognize a “recorded speech prompt” class, where the value of the detail, rather than being a string to be spoken, is a reference to a recorded message to play.

The components of a form are, by convention, always fields; within fields, there will be additional detail to identify the type of data sought. The form 11148 is asking a simple question; it has a single field 11158, which in turn contains a single question input detail 11162, with two choices 11164 and 11168. In preferred embodiments, a question input field with a small number of choices, like this, will be displayed as a pair of buttons on the display; a user who chooses to interact via the GUI will use button selection methods appropriate to the hardware device (on a telephone, normally, the button would be displayed with an associated digit, and the user would press that digit on the phone's keypad).

For spoken input, the form provides a context in which to interpret whatever the user might say. In this case, there are two choices, “Auto” and “Manual,” so we can limit the valid inputs for this form to those two words.

Recall that the question form discussed above was displayed based on an indication in the profile that the user has a meter that the device could communicate with. If the user chooses “Manual,” the value “no” 11166 will be passed to the event management module; based on internal logic, it will proceed to the default case, where the device simply asks the user for the needed information, by displaying the input form 11172. This form specifies some sounds to play when it becomes active: the activation sound 11174 when the form regains focus for some reason, and the creation sound 11176 when it gets focus for the first time.

The speech prompt 11188 is, unlike the speech prompt 11156, a parameterized string: when the prompt is needed, the device will evaluate the parameter details 11190 and 11194. Parameter 0 11190 has as its value the class symbolic time; empty blood glucose readings have this detail filled in at creation time, as with the symbolic time detail 220 of FIG. 2. Parameter 1 11194 has as its value the class name, which is interpreted to be the name of the class of the thing we're trying to fill in, in this case “blood glucose reading.” Thus, for the reading 216, the speech prompt would be evaluated as “Please enter your before breakfast blood glucose reading.”

The single field is a number input 11200, which will expect the user to enter a sequence of digits from the device's keypad (or from buttons on the display, if the device doesn't have a hardware keypad), or by speaking them. Once a number has been entered and confirmed, the value of the number input detail 11200, “value,” indicates that it should be stored as the value of the blood glucose reading currently being obtained. This, in turn, causes a number of other actions. The actual time detail 222 will, based on the value of the important actual time detail 11138, be given the current time as its value; the device will generate a log file using the format specified in detail 11100, for use in communicating these results to a care provider; based on the delta value 11050 and delta display 11052 details, the device will also inform the user of the difference between this reading and the previous reading with the same symbolic time—that is, for reading 216, the previous before breakfast reading.

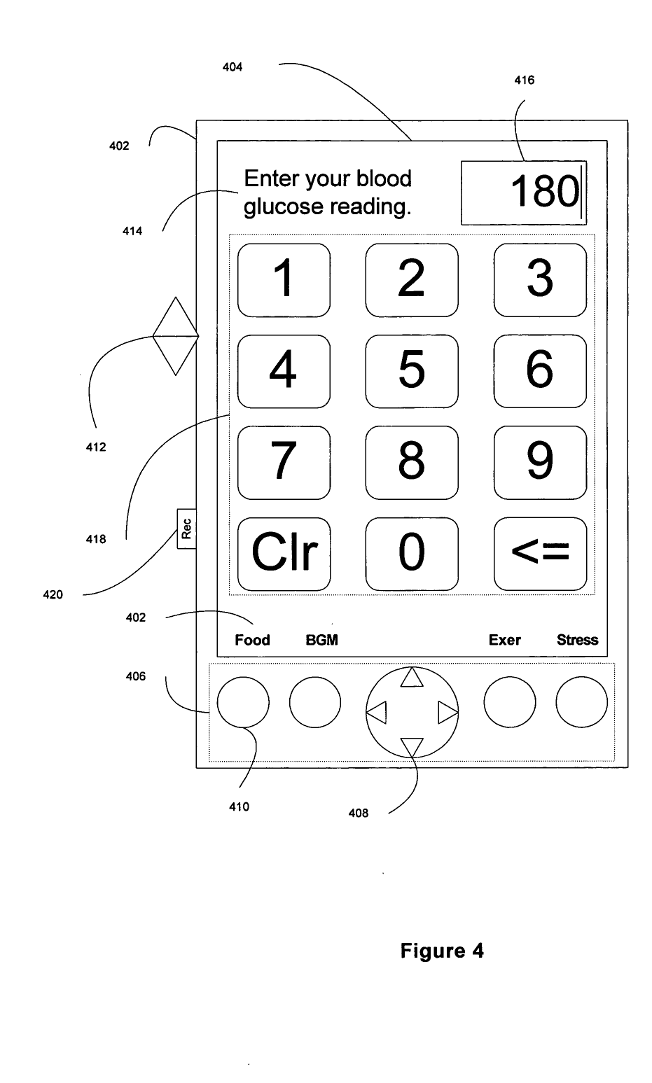

An exemplary display, produced by preferred embodiments on personal digital assistants, is shown in FIG. 4. The numeric keypad 418 is implemented as GUI buttons, large enough for the user to press with his finger; the accumulated number is displayed in a text box 416, next to the prompt 414. The hardware buttons on the PDA, 412, 420, and the set in box 406, can be interpreted according to platform conventions and profile settings, using standard programming techniques.

The number input field 11200 also serves as an indication to the speech input module 146 that a number is the most likely spoken input, when the blood glucose dialog has focus. In general, a bare number is not valid input to the device unless a number input field has focus, because it's ambiguous (did the user mean to enter blood glucose, weight, a number of servings, or a phone number?), so this significantly improves the accuracy of the speech input module.

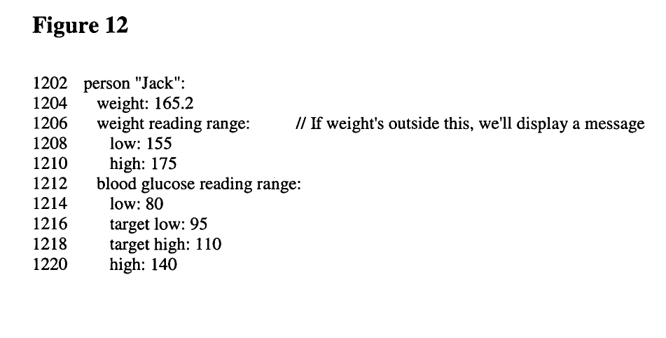

The range class detail 11008 has as its value the class blood glucose reading range. The device will look in the user's personal data for a detail of that class, as shown in the exemplary profile of FIG. 12; the detail 1212 has as details values, in preferred embodiments supplied by the care provider, for reasonable blood glucose readings. The target low 1216 and target high 1218 are, in this example, the range in which the user should keep his blood glucose readings; low 1214 and high 1220 delimit a range outside which some corrective measure should be taken. Preferred embodiments of the device employ this logic to provide immediate feedback to the user when he enters his weight, records some exercise, and so on: the use of details with class values in the typical instance, such as 11008, to reference specific data in the user's personal information of FIG. 12, gives the profile designer a great deal of control over which events will produce messages to the user, and what those messages will be. It will be seen that other mechanisms, already described, could be used here as well: some embodiments of the device might, for some event classes, include hard-coded logic specific to the thing being recorded, rather than using the general mechanism described here.

Preferred embodiments of the invention must also provide facilities for recording more complex events. A blood glucose reading, essential for self-management of diabetes, is a single number; weight, important in a number of applications of the device, is as well. Food consumption and meal planning are equally important, and far more complex. Anyone who is managing his diabetes, watching his weight, or watching his cholesterol will need to know as much as possible about what's in what he's eating, and what damage it might do.

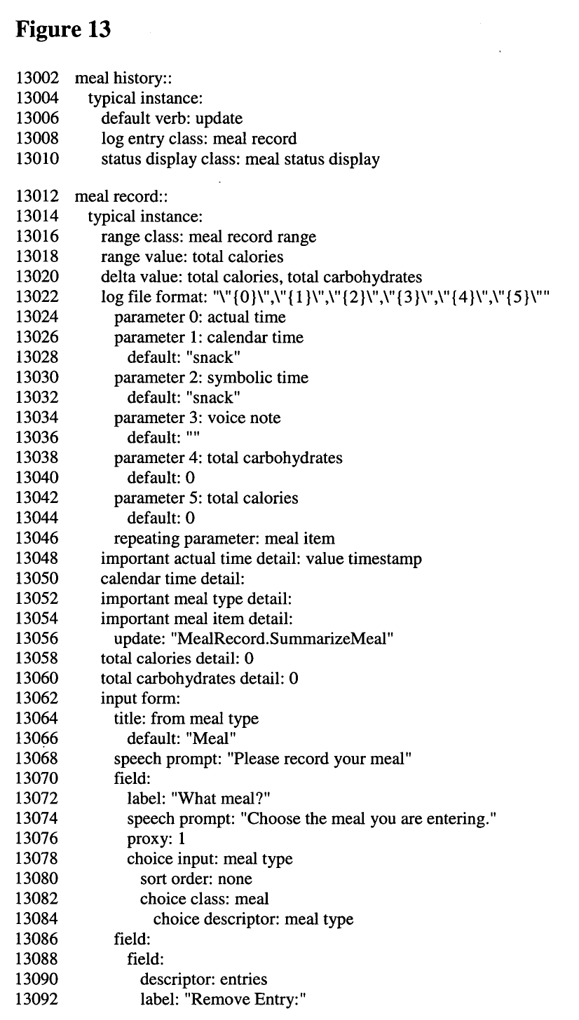

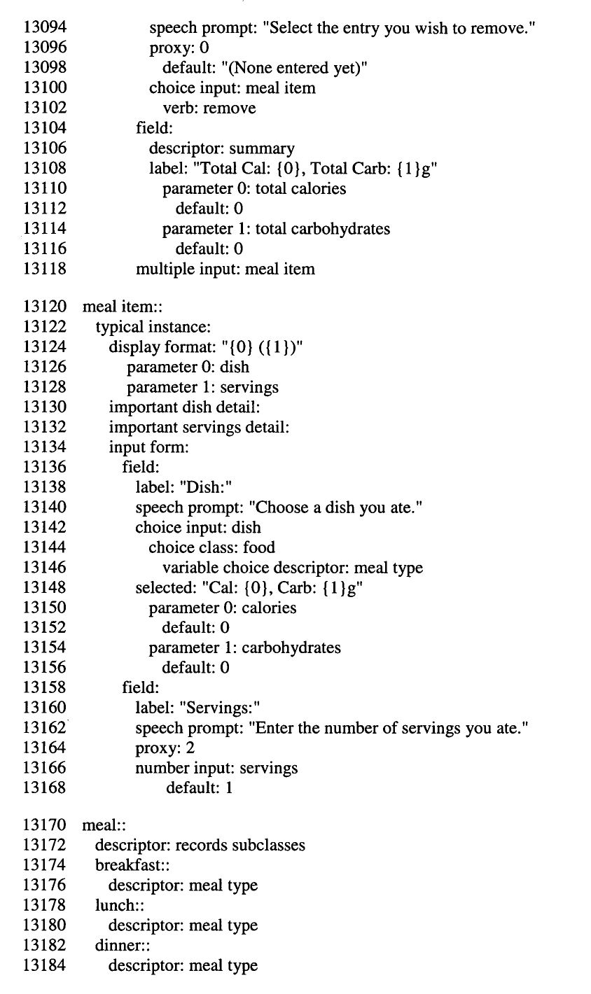

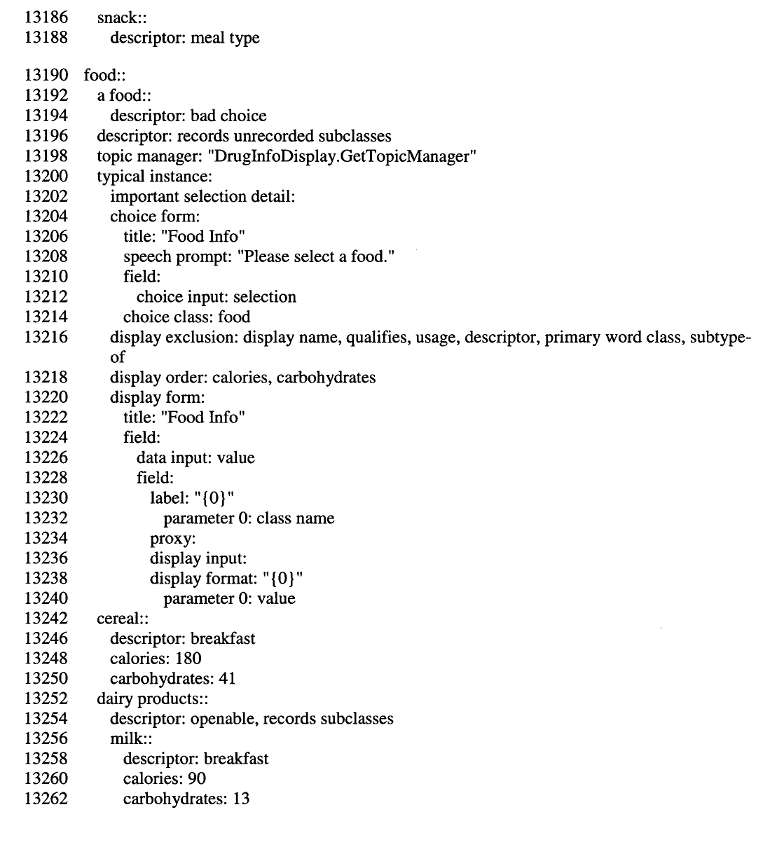

Recording a meal, which consists of more or less arbitrary amounts of several more or less arbitrary foods, is a difficult task. FIG. 13 is an exemplary profile showing the details used to do this in preferred embodiments. The record of the user's meals is kept in a detail of class meal history 13002, which in turn contains a set of meal record details according to the log entry class detail 13008. The structure of a meal record detail is defined by the typical instance detail 13014 of the meal record class 13012.

As with a blood glucose reading, a meal record has time details defined by 13048 and 13050. The remaining details are different. Meal type, defined by 13052, specifies breakfast, lunch, dinner, or snack, according to a mechanism described below; the actual possibilities are stored in the profile. Total calories and total carbohydrates, defined by 13058 and 13060, represent the cumulative nutritional information for the meal; clearly other nutritional information could be tracked as well. Finally, meal item, defined by 13054, represents the things actually eaten. There will generally be several meal item details in a meal record; the mechanism for collecting and recording them is described below.

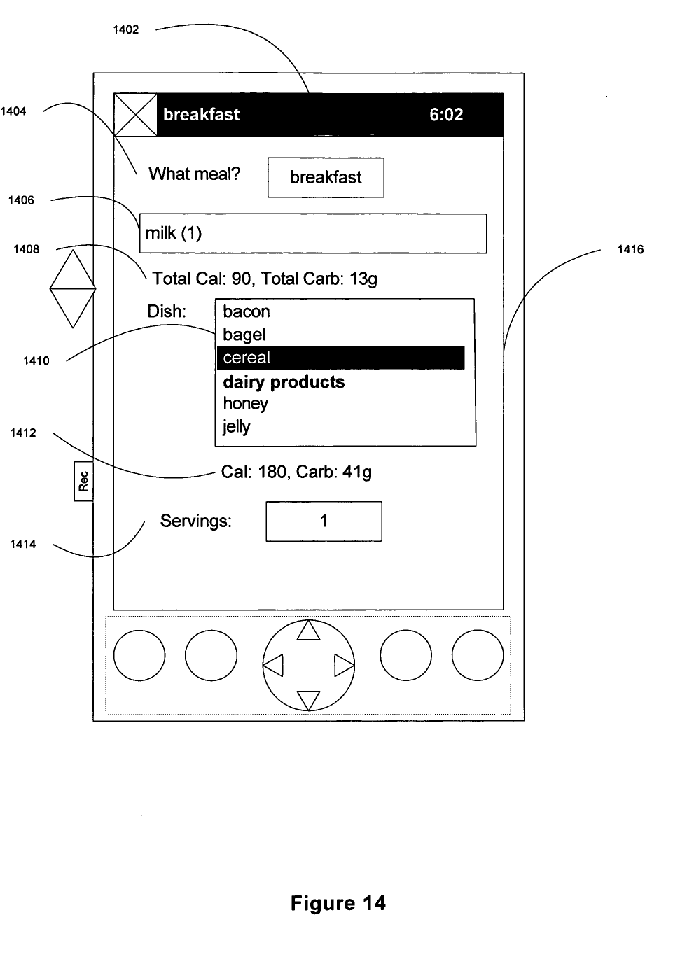

The input of a meal is controlled by the input form 13062 detail of the meal record typical instance. As interpreted by preferred embodiments on a PDA, this produces the GUI form shown in FIG. 14; we will be referring to both FIG. 13 and FIG. 14 throughout this discussion. FIG. 14 is a representation of the user interface as displayed by preferred embodiments implemented on a personal digital assistant; the screen size, and many details of the display, differ significantly for an implementation on a “smart” cell phone.

The form title, 1402, is a reflection of the title detail 13064. The value of the detail, the class “from meal type,” is interpreted as a direction to examine the meal type detail of the record being filled in, and use its value as the title. If the user selects a different meal type, as below, preferred embodiments will update the title of the form to reflect the change.

The field 13070 defines a method for the user to enter the meal he's having. This allows the device to subset the list of foods it will display, on the assumption that oatmeal is not usually served for dinner, and provides information to the care provider about the user's habits. The label 13072 and speech prompt 13074 details are standard. The choice input detail 13078 indicates that this field involves a selection from a limited set of things; the result of the selection will be stored in the meal type detail of the record being filled in, as specified by the value of the detail 13078. The set of possible choices is defined by the choice class detail 13082, further qualified by the choice descriptor detail 13084. This combination is taken to mean that the possible choices are the subclasses of the class meal 13170 that are described as “meal type.” Meal 13170 has the records subclasses descriptor 13172, which makes this search easy; in this exemplary profile, the subclasses of meal are breakfast 13174, lunch 13178, dinner 13182, and snack 13186. Notice that the area on the form in FIG. 14 for the meal type, 1404, shows only the current value of meal type, breakfast. The proxy detail 13076 indicates to the GUI generator 140 that this field can be displayed in abbreviated fashion to ensure that the entire form fits on the screen. The short form of a choice input simply shows the label 13072 and a button containing the current value; if the user presses the button, a new form that allows the user to change the selection will pop up over the meal entry. When it's dismissed, the meal entry form will regain focus, possibly with changes reflecting the change in the meal type detail of the record. This context switch of course is reflected in the set of legal inputs presented to the speech input module 146: the single word “dinner” is much more reasonable as an input when the set of meal choices has been popped up than when there is no reference to a meal expected.

Other, more conversational embodiments of the invention might interpret the field 13070 as an instruction to ask the user the “Which meal?” question before allowing him to enter any foods: the exact details of the interpretation of a particular UI construct in the profile can vary widely without altering the data that the system produces for the care provider. Such an interpretation, call it a “meal wizard,” might be more appropriate for an entirely voice-driven system with somewhat limited ability to handle multiple possible inputs. Simple navigation commands, such as “back” and “next,” and choices from relatively short lists of items, are more likely to work well in those embodiments.

The next field detail 13086 allows the user to add items to the meal, and to remove items that are already present, as well as displaying a summary of the nutritional value of the meal. Removal of existing items, and display of the meal's contents so far, are managed by the subfield 13088, which like 13070 has a proxy detail 13096. The choice input detail 13100 indicates to the UI that this subfield is populated by all meal item details of the current meal record; when the field is being proxied, as at 1406, it will display as a button whose text is generated by enumerating the meal items using the display format 13124 detail of the meal item class 13120. When the user presses the button, as with the meal type above, in preferred embodiments a new dialog will pop up, allowing the user to choose items to remove from the meal. Again, this change in focus can be used to assist the speech input module in understanding an utterance: simply saying “milk” is meaningful when what's listed is the current meal, but more difficult if the focus also includes possible foods to add to the meal. The verb detail 13102 of the choice input 13100 is also useful in managing speech input: “remove milk” is, in this context, unambiguous, because the verb is associated with the entries field.

The dialogs that pop up when proxy buttons such as 1406 are pressed on the display are thread modal. That is, the full meal entry dialog of FIG. 14 would be hidden by the dialog that permits removing items from the meal until that dialog was dismissed. If the user lets the conversation become inactive, the item removal dialog, rather than the main meal entry dialog, will be displayed when the conversation regains the focus.

The next field 13104 produces the summary line 1408. The label string is evaluated, as with prompts, in the context of the meal record we're filling in; the values of the parameter details 13110 and 13114 indicate that the values of “total calories” and “total carbohydrates” details of the meal record should be substituted. Those details are managed based on the update detail 13056 of the prototype meal item detail 13054: it is important to separate the management of the summary details from the user interface, and associate it instead with the meal record itself.

Finally, the multiple input detail 13118 tells the UI that it can collect more than one meal item detail for the meal record. The input of meal items is of course managed according to the typical instance 13122 of the meal item class 13120: the details 13130 and 13132 define the minimum meal item as containing a dish, the thing eaten, and a number of servings. In preferred embodiments, the input form 13134 is simply included in the form for the meal as a whole, where it becomes 1410, 1412, and the proxy button 1414, but clearly other embodiments could handle this differently. The selected detail 13148 appears as the item summary display 1412, which can help the user plan his meal; the UI manager, when the selection in the UI element produced by the choice input detail 13142 changes, automatically updates the display 1412 to reflect the change. The text of 1412 reflects the fact that “cereal” is selected in the choice field 1410; the values were obtained from the detail 13248 and 13250 of the cereal class 13242.

Entry of an actual food item is driven by the choice input detail 13142, which will populate the dish detail of the meal item. Choices are limited to subclasses of the class food 13190 by the choice class detail 13144; further, in preferred embodiments, choices are limited to foods that are appropriate to the meal being entered. The variable choice descriptor 13146 is interpreted to require that any food being listed have a descriptor that matches the current meal type. Thus, cereal 13242 has the descriptor detail breakfast 13246, so will only appear when the user is entering breakfast. This is not a severe limitation: foods can have more than one descriptor value, so could appear for multiple meals, and the user could be permitted to add descriptors to certain foods, if, for example, he often has cereal for lunch. The number of servings is entered according to the field 13158, displayed at 1414.

In the exemplary profile of FIG. 13, the information about foods is limited to calories and carbohydrates, and the size of a serving is not recorded. It will be obvious that the profile can store an arbitrary set of nutritional information, as well as serving sizes, or that the user could specify the amount eaten in other ways: by weight, by volume, and so on. The only requirement is that there be a way to adjust the nutritional information, whatever it is, to reflect the amount consumed. In preferred embodiments, this is a simple multiplication of nutrition per serving, as in FIG. 13, by the number of servings, but it could just as easily be nutrition per ounce, multiplied by the number of ounces, or nutrition per ounce, multiplied by the number of servings and the number of ounces in a serving.

Common Sense Reasoning

U.S. patent application Ser. No. 10/627,799 describes a framework for “common-sense” reasoning. It identifies various domains, such as time, amounts, and locations, and various problems within each domain: evaluation, comparison, and so on. The goal is not to think like a human, but to provide a way to identify, categorize, and use solutions to common reasoning problems of the sort that people solve routinely and relatively effortlessly.

The present invention uses a limited subset of that framework, with particular focus on an inventory common sense domain, and problems associated with it. Many of the conditions for which the present invention can be used require supplies of some sort. In the case of diabetes, these might include syringes, test strips for a blood glucose monitor, and so on, but many medical conditions involve taking one or more prescription drugs regularly, and even managing one's diet carefully requires particular attention to the food one consumes

In preferred embodiments, the inventory domain uses functions primarily from the time and amounts domains described in U.S. patent application Ser. No. 10/627,799. The user must, implicitly or explicitly, log consumption of supplies, but of course this is generally implicit. Current blood glucose monitors consume a test strip and a lancet for each test, so the act of entering a new blood glucose reading is enough for the device to update the inventory. Similarly, preferred embodiments wherever possible remind the user to take prescription drugs at appropriate times; dismissing the reminder dialog is taken as a confirmation that the drug was taken, so, again, the inventory can be updated.

The interesting function of inventory management, aside from keeping track of what you have, is deciding when it's time to get more. There are four factors involved in that decision: the number currently on hand, the expected rate of consumption, the expected time to obtain a new supply, and the possibility that the re-supply will take longer than expected. For the number on hand, we can assume a reasonable degree of accuracy, though it is not expected to be exact. The expected rate of consumption of course starts with the prescribed level: the user should take four of these pills every day. In some cases, it may be reasonable for the user to consume more than the prescribed amount; an ad-hoc blood glucose reading is perfectly acceptable, but most prescription drugs discourage taking extra doses. In preferred embodiments, as discussed above, there is extensive historical information available (assuming that the user is reasonably reliable about logging his actions) for the system to analyze, which can lead to more accurate consumption estimates: if the user almost never does his prescribed Saturday morning blood glucose reading, inventory management can adjust the expected consumption accordingly.

Restocking of an inventoried item can proceed in two ways. In the simplest, the device tells the user it's time to buy more, and reminds him periodically until he confirms that he has restocked. The amount of time between the initial notification and the confirmation provides an explicit measurement of the time required to restock, and therefore how small the supply can be before the device suggests restocking.

With the increasing availability of web services, it is becoming feasible for devices such as the present invention to order supplies themselves, and either arrange for delivery or have the order be ready for pickup. This can remove much of the unpredictability from restocking: the web service can provide information about shipping dates and methods at the time of order; ideally, the device would shop among various suppliers based on price, delivery times, and so on. Although preferred embodiments of the invention do not assume that a network connection is always available, the network interface 160 will detect a connection, and execute whatever operations have been placed on its calendar. For items like prescription drugs, where it will generally be unacceptable for the user to run out, the device will have to begin the automated ordering process, if it's possible, early enough to allow the user to restock “manually” if the network never becomes available. In addition, the inventory manager in preferred embodiments has some semantic information about the user's schedule. In particular, it may have to take the user's travel plans into account when it's deciding whether to restock, and how much to order: it does no good to have a new order of drugs delivered to the user's house if he's out of the country when the shipment arrives.

As mentioned above, preferred embodiments of the present invention need only a limited subset of the common sense reasoning framework described in U.S. patent application Ser. No. 10/627,799. The time domain discussed there is important in this invention: the device needs to evaluate time expressions like “before breakfast” or “mid-afternoon” in ways that make sense for a specific user of the device. To do this, it combines general information about meal times with information about the individual user's habits. During initial setup of the device, the user might be asked to estimate his usual meal times; over time, as the user records his meals, the profile will accumulate data about actual times when meals appear to happen, and will then be able to adjust those estimates to reflect variations due to holidays, weekends, travel, and so on.

Some aspects of the amount reasoning domain discussed in U.S. patent application Ser. No. 10/627,799 also apply to the present invention. For prescription drugs, of course, we require a fairly high level of precision, but it is not reasonable to expect users to enter the exact amounts of different foods consumed. Generally, for food, the device deals in units of “servings,” the sizes of which are defined in the profile; common sense reasoning comes into play when the user's weight, food consumption, and exercise don't correspond well enough. That is, if the user's weight is increasing when the amount of exercise he reports should be sufficient to match the amount of food he reports, some adjustment might be required: it may be that the user is typically under-reporting his food consumption, over-reporting his exercise, or that he has some metabolic problems. Common sense reasoning about amounts is the beginning of this, but of course there's also domain knowledge encoded in software to get beyond that to a course of action.

Common sense domains from U.S. patent application Ser. No. 10/627,799 such as the language domain, the name domain, the class domain, or the location domain, are not required in preferred embodiments of the present invention. In particular, because the device accepts either GUI commands or speech input with a very restricted grammar, there is no issue of understanding natural language; similarly, the management of complete lists of known drugs, foods, or exercises eliminates much of the need for intelligence in handling the names of things. Beyond the limited common sense reasoning in these domains required to load the profile, as discussed in U.S. patent application Ser. No. 10/627,799, preferred embodiments here are constructed to avoid reasoning in these domains, because the implementation and run-time cost greatly exceeds the marginal value to the user.

Domain Knowledge

In U.S. patent application Ser. No. 10/627,799, the assumption is made that all knowledge specific to the domain of the particular application will be stored in the profile. Preferred embodiments of the present invention relax this requirement: the profile remains as a knowledge store: in addition to dynamic state information, it contains static knowledge, whether domain-specific or not. Procedural knowledge, on the other hand, is stored exclusively in conventional computer code, which of course uses the knowledge store while it runs; the profile may also store information about where the code for a specific purpose can be found.

FIG. 13, for example, shows a simple representation of the nutritional values of food items, something that is useful in domains such as diabetes management or weight loss. Additional information can be added using the same methods, along with information about appropriate amounts to consume: calories, carbohydrates, vitamins, cholesterol, and so on. In preferred embodiments, food consumption is logged, along with the nutritional information about the food consumed; the logic to obtain that information from the user, in managed conversation 134, needn't know anything in particular about diabetes, or even food, beyond what is explicit in the profile. Similarly, information about exercise can be collected based solely in the profile contents. However, preferred embodiments of the present invention make the link between diet and exercise in the disease management module 122: it is there that an increase in food consumption will trigger more persistent reminders to exercise.

An example of domain-specific procedural knowledge in the diabetes management application discussed here is communication with devices such as blood glucose monitors. As shown in FIG. 2, the profile contains information, at 204 and 288, about the blood glucose monitor owned by the user, but it is limited to the type of meter, and some configuration information. In preferred embodiments, it does not contain code to manage interactions with such devices: details of the command set, response formats, and physical and logical communications protocols. Instead, the meter's handler detail 296 identifies a class within the application executable that implements these interactions. Specific operations that might be required by code that uses data from the meter are accessed using methods of that class, identified by method details like 298.

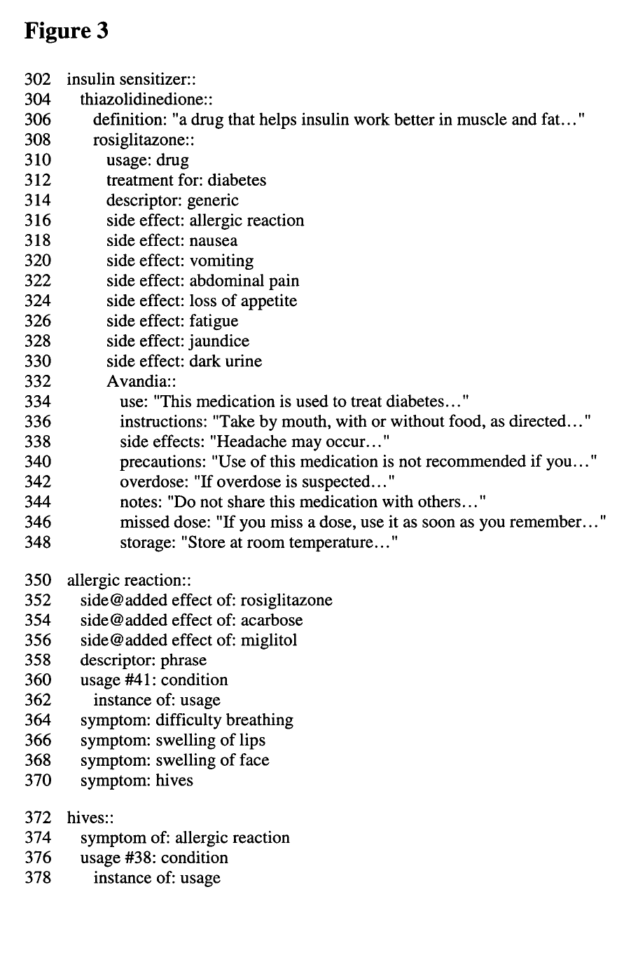

FIG. 3 illustrates the division of domain knowledge between the profile and code in a slightly different context. The profile includes information about a class of drugs 302 known as insulin sensitizers; among those drugs is one whose trade name is Avandia 332, more generically rosiglitazone 308. The profile includes text directions for using the drug 336, dealing with a missed dose 346, and so on; in preferred embodiments, this is uninterpreted data that the device will display or read to the user when appropriate. Drugs often have side effects; rosiglitazone has the set 316-330, including an allergic reaction 316. Elsewhere in the profile, the device has information about allergic reactions 350. This includes an automatically generated back reference 352 to rosiglitazone, and a set of symptoms 364-370, including hives 370. Finally, the profile contains information about hives 372.

Preferred embodiments of the device allow the user to enter information about his well-being, including any unusual conditions he may be experiencing. The list of possible symptoms can be derived entirely from information in the profile; in the example shown, any class with a usage detail whose value is condition, such as the one at 376 for hives, will be listed. However, once the user has entered a condition, it might be desirable for the device to provide more information about this, including possible causes. If the user reports that he broke out in hives, then it is simple reasoning to ask, is that a symptom of anything? The symptom of detail 374 provides a possible answer; similarly, the side effect of detail 352 allows the device to reason that, if the user is taking any kind of rosiglitazone, and especially if he recently started taking it, he may be having a reaction to it. All the reasoning is based on information in the profile; the classes, such as “symptom of” and “side effect of,” are identified in code. The links among the classes are described by reasoning procedures, not by declarations in the profile. Finally, the disease management code has logic that embodies the idea that a recently prescribed drug is a more likely cause of a new allergic reaction than one that's been in use for several months. Other embodiments of the invention might move some of this knowledge into the profile, as an implementation detail; for preferred embodiments, the design principle is that the profile will contain as much information as is consistent with reasonable performance on a small device.

It will be further appreciated that the scope of the present invention is not limited to the above-described embodiments but rather is defined by the appended claims, and that these claims encompass modifications of and improvements to what has been described.

1. A system for self-management of health, comprising:
logic to initiate dialogue with a user to solicit health information from the user using a natural language (NL) interface;
logic to respond to unsolicited health information from the user provided via a natural language (NL) interface;
health management logic to semantically process health information from the user in accordance with pre-specified health management rules to facilitate user self management of health.

2. The system of claim 1 wherein the natural language interface is a constrained natural language.

3. The system of claim 1 wherein the natural language interface interacts with a speech recognition system.

4. The system of claim 1 where the health management logic includes a common sense reasoning logic to semantically process NL input from the user according to rules to emulate common sense reasoning.

5. The system of claim 1 wherein the health management logic is responsive to previous interaction with the user so as to adapt behavior to user habits.

6. The system of claim 1 further comprising a profile structure for representing knowledge and information and wherein the logic to initiate dialogue, the logic to respond unsolicited health information from the user, and the health management logic interact with the profile, said profile including a persistent section of user data.

7. The system of claim 1 further comprising a profile structure for representing knowledge and information, said profile including an enumerated set of class specifications.

8. The system of claim 1 further comprising a profile structure for representing knowledge and information, said system further including journaling logic to record changes to the profile information.
